(19) United States
(12) Patent Application Publication
(10) Pub. No.: US 2026/0290140 A1
(43) Pub. Date: Sep. 24, 2026

(54) SYSTEM

(71) Applicant: SoftBank Group Corp., Tokyo (JP)

(72) Inventor: Hiroyuki MIZUNO, Tokyo (JP)

(73) Assignee: SoftBank Group Corp., Tokyo (JP)

(21) Appl. No.: 19/567,030

(22) Filed: Mar. 14, 2026

(30) Foreign Application Priority Data
Mar. 19, 2025 (JP) 2025-045157

(51) Int. Cl. G08B 21/06; G06F 3/16; G06V 40/16; G08B 3/10; G10L 25/63

(52) U.S. Cl. CPC G08B 21/06; G06F 3/165; G06V 40/174; G08B 3/10; G10L 25/63

(57) ABSTRACT

A system includes a processor that is configured to detect a drowsiness state of a user by using a sensor and analyze data obtained from the sensor to convert a degree of drowsiness of the user into a numerical value, determine a genre and an intensity of music by using a generative artificial intelligence model on the basis of the determined degree of drowsiness, and input, to the generative artificial intelligence model, a prompt for instructing generation of music on the basis of the determined genre and intensity so as to automatically generate original music.

### CROSS-REFERENCE TO RELATED APPLICATION

This application is based on and claims priority under 35 USC 119 from Japanese Patent Application No. 2025-045157 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for awakening a drowsy user or maintaining user alertness typically rely on simple, static stimuli such as fixed alarm sounds, pre-recorded music playlists, or manual user selection of content. These techniques do not quantitatively detect and evaluate the degree of drowsiness of the user, and therefore are not able to adapt the type or intensity of stimulation to the user's actual physiological or psychological state. As a result, the stimulation may be too weak to effectively awaken a severely drowsy user or may be unnecessarily strong and uncomfortable for a slightly drowsy user.

Furthermore, existing systems generally do not utilize generative artificial intelligence models to dynamically generate original music tailored to the user's drowsiness level. Instead, they depend on limited, pre-existing content, which can reduce long-term effectiveness due to habituation and lack of personalization. In addition, conventional systems often ignore the user's emotional state, such as stress, irritation, or relaxation, as expressed by voice tone and facial expression, and therefore cannot adjust the music genre or intensity in real time to improve user comfort and acceptance.

Accordingly, there is a need for a system that can: (i) detect and quantify the degree of drowsiness of a user by analyzing sensor data, (ii) determine an appropriate music genre and intensity based on the quantified drowsiness degree, (iii) automatically generate original music using a generative artificial intelligence model according to the determined genre and intensity, and (iv) optionally recognize the user's emotion from voice tone and facial expression and adjust the music in real time, thereby providing more effective and personalized stimulation to awaken or maintain the alertness of the user.

### SUMMARY

In order to solve the above-described problems, according to one aspect of the present invention, there is provided a system comprising a processor, wherein the processor is configured to detect a drowsiness state of a user by using a sensor and analyze data obtained from the sensor to convert a degree of drowsiness of the user into a numerical value. By numerically quantifying the degree of drowsiness, the processor can accurately classify and evaluate the user's state and use the resulting numerical value as an input parameter for subsequent music control.

The processor is further configured to determine a genre and an intensity of music by using a generative artificial intelligence model on the basis of the determined degree of drowsiness. For example, the processor may determine a high-intensity, stimulating genre when the numerical value indicates a high degree of drowsiness and may determine a lower-intensity, more moderate genre when the numerical value indicates a slight degree of drowsiness. In this manner, the processor can adaptively select music parameters that are appropriate to the user's current drowsiness level.

The processor is further configured to input, to the generative artificial intelligence model, a prompt for instructing generation of music on the basis of the determined genre and intensity so as to automatically generate original music. The prompt may include information indicating the selected genre, the selected intensity, and optional parameters such as tempo, key, or duration. By using the generative artificial intelligence model in response to the prompt, the system can generate new, original music content that is tailored to the user's state, rather than relying on fixed, pre-recorded tracks.

In one embodiment, the processor is configured to play back the generated music to the user via a speaker. By reproducing the automatically generated music through a speaker or other audio output device, the system can provide appropriate acoustic stimulation to awaken the user or maintain the user's alertness for a predetermined period.

In another embodiment, the processor is configured to analyze a tone of a voice of the user and a facial expression of the user to recognize an emotion of the user, and adjust, in real time, the genre and the intensity of the music on the basis of the recognized emotion. For example, when the user's emotion indicates irritation or discomfort, the processor may reduce the intensity or modify the genre to a less stressful style while still maintaining an awakening effect. By combining drowsiness quantification with emotion recognition and real-time adjustment of music parameters, the system can achieve more effective, personalized, and acceptable stimulation that responds dynamically to both the user's physiological and emotional conditions.

The term “processor” refers to any hardware, firmware, or combination thereof, including one or more CPUs, microcontrollers, DSPs, ASICs, FPGAs, or system-on-chip devices, that executes instructions to perform the functions described in the present specification and claims.

The term “sensor” refers to any device or combination of devices that measures or detects a physical, physiological, or environmental quantity related to the user, such as eye movement, eyelid closure, heart rate, brain activity, body motion, or ambient conditions, and outputs corresponding sensor data usable for detecting a drowsiness state.

The term “drowsiness state” refers to a physiological or psychological condition of the user associated with reduced alertness, increased sleepiness, or a tendency to fall asleep, which can be detected or inferred from sensor data.

The term “degree of drowsiness” refers to a quantified or classified level of the user's drowsiness state, expressed as a numerical value or within a discrete range, which indicates the severity or intensity of the user's sleepiness.

The term “convert a degree of drowsiness into a numerical value” refers to processing sensor data to calculate, estimate, or assign a numerical indicator or score that represents the degree of drowsiness of the user.

The term “generative artificial intelligence model” refers to a machine learning model, such as a neural network, a transformer model, or a diffusion model, that is trained to generate new content, including but not limited to music data, in response to input conditions or prompts.

The term “genre of music” refers to a category or style of music characterized by particular musical features, such as melody patterns, rhythms, instruments, tempo, or mood, including but not limited to rock, pop, metal, jazz, classical, or Detroit Metal City-style music.

The term “intensity of music” refers to a parameter indicating the strength, energy, loudness, tempo, rhythmic density, or overall stimulation level of the music, which can be adjusted to increase or decrease the awakening effect on the user.

The term “prompt” refers to information, including textual, symbolic, or parameter-based data, that is input to the generative artificial intelligence model to instruct or condition the model on how to generate music, and that may specify at least the genre of music and the intensity of music.

The term “original music” refers to music data that is newly generated by the generative artificial intelligence model in response to a prompt and is not a mere reproduction of pre-existing audio recordings.

The term “play back the generated music” refers to outputting the generated music as audible sound through an audio reproduction device so that the user can listen to the music.

The term “speaker” refers to any audio output device that converts electrical or digital audio signals into audible sound waves perceivable by the user, including built-in speakers, external speakers, headphones, or earphones.

The term “tone of a voice of the user” refers to acoustic characteristics of the user's speech, such as pitch, loudness, timbre, prosody, and modulation, which can be analyzed to infer the user's emotional state.

The term “facial expression of the user” refers to visible configurations or movements of the user's facial muscles, including positions or motions of eyes, eyebrows, mouth, and other facial features, which can be analyzed to infer the user's emotional state.

The term “emotion of the user” refers to an affective state of the user, such as happiness, sadness, anger, irritation, relaxation, or stress, which can be recognized by analyzing at least the tone of the user's voice and the facial expression of the user.

The term “real time” refers to processing and adjustment performed with a latency sufficiently short that changes in the user's emotion or state are reflected in the music while the user is still experiencing that emotion or state, such that the user perceives the system response as substantially immediate.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi®, Bluetooth®, and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

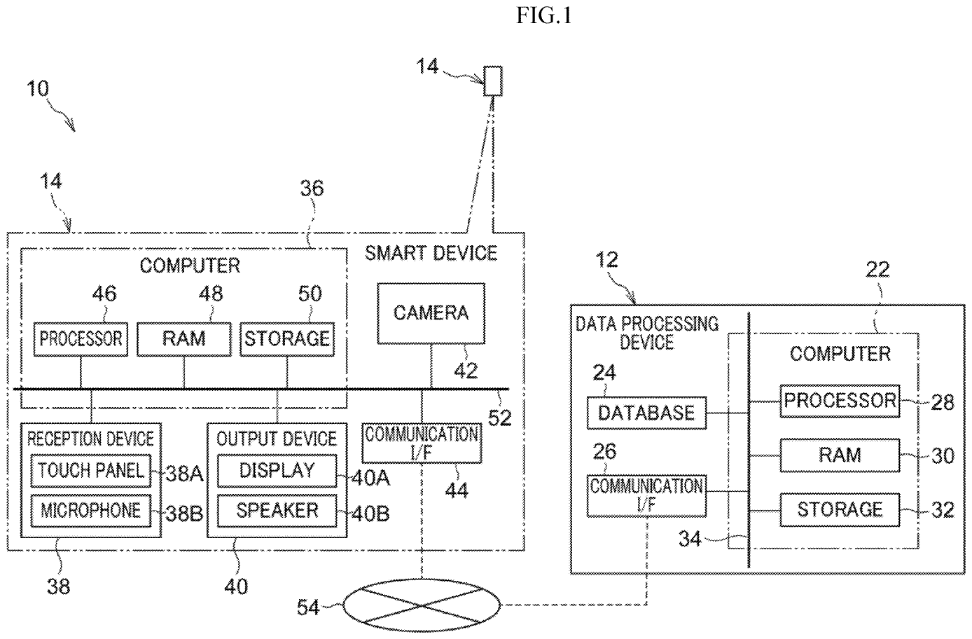

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

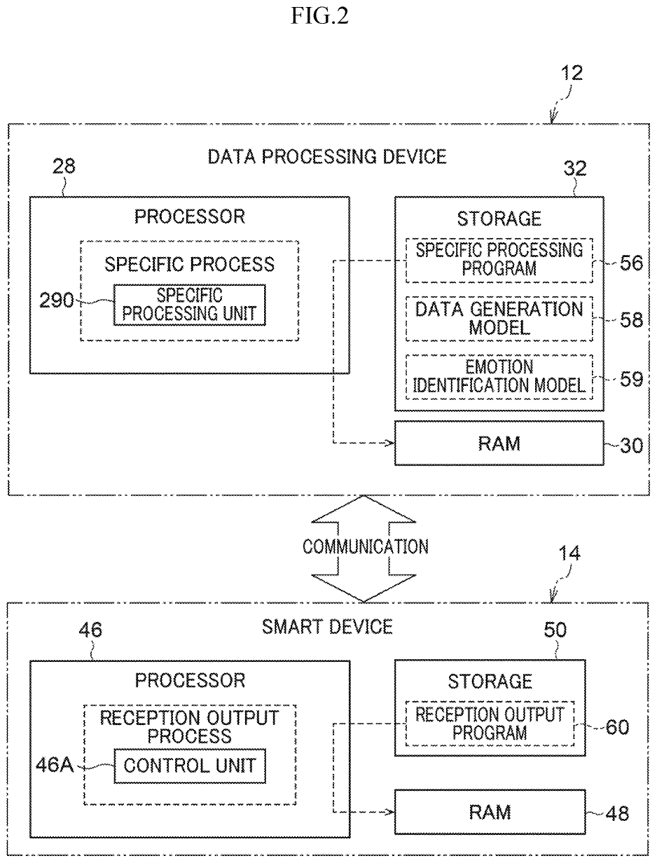

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional content delivery systems that present audio content to a user based on a user's state generally rely on static playlists, simple rule-based mappings, or manually curated content selections. Such systems typically do not leverage a generative AI model driven by dynamically structured prompt sentences, and do not tightly integrate the end-to-end flow from user state acquisition, through prompt construction and generative model invocation, to audio synthesis, network transmission, and terminal-side playback control. As a result, these systems are limited in their ability to (i) generate individualized audio content in real time that is precisely adapted to a current arousal state of the user, (ii) optimize the utilization of computational resources used for generative processing, and (iii) iteratively improve their behavior based on user feedback and in-playback interaction signals.

Moreover, existing generative AI-based audio systems are often designed as standalone tools or offline generation utilities. They typically accept free-form textual prompts with minimal machine-readable structure, generate media content, and leave the orchestration of data acquisition, structured prompt construction, content transformation, transport, and playback to separate ad hoc components. This fragmented architecture can introduce inefficiencies in the computing pipeline, such as redundant data transformations, suboptimal prompt conditioning, and lack of systematic feedback loops. It can also cause latency and instability when attempting to adapt content in real time based on user operation information or biological information acquired during playback.

In addition, many systems that monitor user state using sensors or interaction data do not integrate such measurements into a closed-loop optimization framework that refines both the prompt sentences and the decision logic for content attributes over time. In such systems, evaluation information from the user regarding generated content is either not captured at all or is stored in a way that is not effectively exploited to adjust the generative model input parameters. Consequently, the computing system fails to progressively improve its mapping from user state to generative model prompt conditions, and thus cannot enhance system-level performance metrics such as responsiveness, relevance of content, or effectiveness in adjusting the user's arousal state.

Accordingly, there is a need for an improved computer-implemented system that (i) structurally converts user state information related to arousal into machine-usable evaluation information, (ii) deterministically constructs structured prompt sentences for a generative AI model including attribute information such as a type and a stimulation level of acoustic content, (iii) efficiently manages the transformation of generated structured data into digital audio data and its delivery to a terminal, and (iv) incorporates user evaluation information and in-playback interaction or biological signals into an adaptive update of both the prompt configuration and the decision logic for selecting content attributes. Such a system should improve the operation of the computer itself by providing a more efficient, integrated, and feedback-driven pipeline for generative audio content processing, transmission, and playback control.

The specific processing by the specific processing unit 290 of the data processing device 12 in Example 1 is realized by the following means.

The present invention provides a server comprising at least one processor and at least one storage device storing instructions which, when executed by the at least one processor, cause the at least one processor to acquire, via an information input unit or detection unit of a terminal, state information related to an arousal state of a user; analyze the state information to convert the state information into evaluation information indicating a degree of the arousal state; determine, on the basis of the evaluation information, attribute information of acoustic content to be included in a prompt sentence for a generative information processing model, the attribute information including at least a type of the acoustic content and a stimulation level of the acoustic content; construct the prompt sentence including the attribute information and the evaluation information in a structured, machine-readable format; input the prompt sentence to the generative information processing model and cause the generative information processing model to generate structured data for the acoustic content as time-series signal data or event sequence data; convert the structured data into digital audio data using a software synthesis mechanism and an audio signal conversion mechanism; compress and store the digital audio data in the at least one storage device and output the compressed digital audio data in a format transmittable to the terminal; cause the terminal to obtain the compressed digital audio data and, through playback control executed at the terminal, control an output level and a playback time of the compressed digital audio data and present the acoustic content to the user via an acoustic output unit; acquire, via the terminal, evaluation information from the user regarding the generated acoustic content; store the evaluation information in association with the evaluation information indicating the degree of the arousal state and the attribute information of the acoustic content; and update, on the basis of stored results, at least one of a configuration rule set for generating the prompt sentence and a decision logic for determining the attribute information of the acoustic content, and optionally further cause the terminal, during playback, to send operation information or biological information of the user so that the server can sequentially change at least one of the stimulation level or the type of the acoustic content in the prompt sentence and re-invoke the generative information processing model to generate new acoustic content for real-time playback adjustment. This enables an integrated and improved computer-implemented processing pipeline in which user state information is systematically transformed into structured prompt sentences for a generative AI model, generative output is efficiently converted and transmitted as digital audio data, and user feedback and interaction signals are used to adapt and optimize the prompt construction and content attribute decision logic over time, thereby enhancing the effectiveness, responsiveness, and computational efficiency of the overall audio content generation and delivery system.

The term “processor” refers to one or more hardware-based computation units, such as a central processing unit or a graphics processing unit, configured to execute instructions and perform data processing operations.

The term “terminal” refers to an electronic apparatus including at least a user interface, an information input unit, a communication unit, and an acoustic output unit, configured to exchange data with a server and to present audio content to a user.

The term “information input unit” refers to a functional component of the terminal that acquires user-related information through an input operation or sensor measurement, including, for example, a touch-sensitive panel, a button, a microphone, a camera, or a similar input device.

The term “detection unit” refers to a functional component of the terminal or server-side device that detects physical or physiological parameters of the user or the environment by using one or more sensors, such as a motion sensor, an optical sensor, or a biological sensor.

The term “state information related to an arousal state” refers to information indicating a physical or psychological alertness level of a user, including, for example, subjective input such as a selected drowsiness level, or objective measurements such as facial expression, voice characteristics, or biological signals.

The term “evaluation information” refers to data derived from the state information related to an arousal state, which quantitatively or qualitatively represents a degree of the arousal state in a form suitable for computation and decision processing.

The term “attribute information of acoustic content” refers to information specifying characteristics of audio content to be generated, including at least a type of the acoustic content and a stimulation level of the acoustic content, and optionally further including parameters such as duration, tempo, loudness, or complexity.

The term “type of the acoustic content” refers to a classification of audio content according to at least one of style, genre, instrumentation, or sound design characteristics, such as rhythm pattern, harmonic structure, or timbral profile.

The term “stimulation level of the acoustic content” refers to a parameter or set of parameters indicating a strength of sensory or psychological stimulation provided by the acoustic content, including but not limited to tempo, loudness, rhythmic density, and perceived energy.

The term “prompt sentence” refers to structured textual or symbolic data supplied as input to a generative information processing model, the data encoding at least the evaluation information and the attribute information of acoustic content, and being formatted to condition the behavior of the generative information processing model.

The term “generative information processing model” refers to a learned computational model configured to generate new data samples, such as time-series signal data or event sequence data, based on input conditions including a prompt sentence, and implemented using, for example, a neural network or a probabilistic generative architecture.

The term “structured data for the acoustic content” refers to machine-readable data representing the acoustic content in a non-audio, symbolic, or intermediate format, including, for example, a time-series event sequence, a control sequence, or another structured representation that can be converted into audio signals.

The term “time-series signal data” refers to data expressing values of a signal as a function of time, including sequences of audio-related or control-related values generated at discrete time steps or as continuous-time sampled data.

The term “event sequence data” refers to a sequence of discrete events, each event having at least a timing parameter and one or more attributes such as pitch, duration, intensity, or instrument identifier, suitable for representing musical or auditory structures.

The term “software synthesis mechanism” refers to a software-based component or program configured to convert structured data for acoustic content, such as event sequence data, into digital audio signals by performing processes including sound synthesis, instrument rendering, and mixing.

The term “audio signal conversion mechanism” refers to a functional component that performs at least one of format conversion, sampling rate conversion, filtering, or encoding on digital audio data in order to obtain audio signals suitable for storage, transmission, or playback.

The term “digital audio data” refers to audio information represented as digital samples or encoded audio frames, which can be stored, transmitted, decoded, and rendered as acoustic signals by electronic devices.

The term “storage unit” refers to any hardware-based data storage element, including, for example, a semiconductor memory, a magnetic storage device, or a solid-state drive, configured to persistently or temporarily store digital data.

The term “playback control unit” refers to a functional component implemented in software and/or hardware in the terminal, configured to control operations related to audio playback, including starting, stopping, pausing, seeking, volume adjustment, and playback timing management.

The term “acoustic output unit” refers to a component of the terminal configured to output sound to the user, including at least one of a loudspeaker, an earphone, or a headphone, driven by an audio amplification and conversion stage.

The term “evaluation information from the user regarding the generated acoustic content” refers to data indicating a reaction, preference, satisfaction level, or effectiveness assessment provided explicitly or implicitly by the user in response to presented acoustic content.

The term “configuration of the prompt sentence” refers to a rule set, template, or algorithm that determines a structure, field arrangement, wording, or encoding method of the prompt sentence used for conditioning the generative information processing model.

The term “decision logic for the attribute information of the acoustic content” refers to a rule-based, statistical, or learned procedure that determines the attribute information, including the type and stimulation level of acoustic content, based on at least the evaluation information related to the arousal state and optionally other contextual data.

The term “operation information of the user” refers to data representing user interactions with the terminal or system, including, for example, touch inputs, button operations, slider adjustments, or command selections performed during or around playback.

The term “biological information of the user” refers to data acquired from a sensor indicating at least one physiological parameter of the user, such as heart rate, skin conductance, respiration, or eye movement.

The term “real-time playback adjustment” refers to a process in which parameters of acoustic content being presented, including at least one of the type or stimulation level, are modified while playback is ongoing or between successive pieces of content, in response to operation information, biological information, or other up-to-date state information.

In one embodiment, a server, a terminal, and a user cooperatively implement the system.

### A. System Architecture and Hardware/Software Configuration

The server includes at least one processor, at least one memory device, at least one storage device, and at least one network interface. The server runs an operating system such as a general-purpose server operating system, and executes application software including a web server framework, an application logic module, a data management module, and a generative AI interface module.

The terminal includes a processor, a memory, a storage device, a display unit, an information input unit such as a touch panel or hardware buttons, an acoustic output unit such as speakers or headphones, and a wireless or wired communication unit. The terminal runs a client operating system such as a mobile operating system and executes an application that communicates with the server, presents a user interface, and controls audio playback using an audio playback framework.

The server uses a database management system, such as a relational database, to store user-related records, state information, evaluation information, prompt sentence logs, generated content metadata, and feedback data. The server also uses an audio processing library, such as an audio conversion tool and a synthesis engine (for example, a software synthesizer functionally similar to a general MIDI synthesizer), to convert structured data into digital audio data. The server optionally uses a multimedia processing framework, such as a tool equivalent to a general-purpose audio encoder, to compress audio into a file format such as MPEG audio or advanced audio coding.

The server accesses a generative AI model for music or acoustic content, implemented, for example, as a transformer-based neural network or a recurrent neural network running on a machine learning framework such as a deep learning library. The generative AI model may be deployed locally on the server with hardware acceleration (for example, a graphics processor unit or a tensor accelerator) or accessed via a remote network service providing a generative AI API.

### B. Data Structures and Internal Representations

The server internally represents state information related to a user's arousal state as structured records. Such state information includes discrete labels indicating subjective drowsiness (for example, “a little sleepy”, “sleepy”, “too sleepy”) and may additionally include numerical features derived from sensor signals, such as average heart rate, blinking frequency, or voice pitch variance.

The server converts this raw state information into evaluation information by mapping each discrete label and sensor-derived feature to a unified representation. In one implementation, the evaluation information includes at least:
A normalized arousal score (for example, a value in a fixed numeric range).
A categorical code indicating a drowsiness class.
Optionally, secondary indicators such as recent trend (improving or worsening arousal).

The server represents attribute information of acoustic content as structured data containing:
A content type field (for example, “aggressive metal style”, “upbeat rock style”, “electronic pop style”).
A stimulation level field (for example, “medium”, “high”, “maximum”).
Additional parameters such as target tempo, target loudness, target duration, rhythmic density, and harmonic complexity.

The server constructs a prompt sentence as a machine-readable text sequence that encodes both the evaluation information and the attribute information. Unlike ad hoc natural language prompts, the prompt sentence uses a structured format with explicit segments and key phrases, which stabilizes the behavior of the generative AI model and improves reproducibility and computational efficiency.

For example, when the user is “too sleepy”, the server may construct the following prompt sentence:
User drowsiness state: too sleepy
Target duration: 3 minutes
Music genre and style: aggressive metal in the style of a high-energy distorted guitar band, with distorted electric guitars, fast double-bass drum patterns, and intense shouted-like lead lines
Intensity: maximum
Target tempo: 190-210 BPM
Target loudness: high, with strong dynamic impact
Mood: extremely energetic, shocking, and awakening
Output format: structured symbolic sequence suitable for conversion to guitar, bass, and drum arrangement
When the user is “a little sleepy”, the server may construct another example:
User drowsiness state: a little sleepy
Target duration: 3 minutes
Music genre and style: electronic pop with a steady beat, soft synthesizer pads, and a light but catchy lead melody
Intensity: medium
Target tempo: 120-135 BPM
Target loudness: medium, not too aggressive
Mood: refreshing, slightly stimulating, comfortable for work or study
Output format: structured symbolic sequence or audio suitable for background listening

### C. Generative AI Model Architecture and Training

The server uses, as the generative AI model, a trained neural network configured to generate time-series signal data or event sequence data from a prompt sentence. In one embodiment, the generative AI model is a transformer-based sequence model. The model includes:
An input embedding layer that maps text tokens in the prompt sentence and musical tokens into high-dimensional vectors.
A stack of self-attention layers, each comprising multi-head attention, layer normalization, and feedforward sub-layers.
Positional encoding to represent time order of tokens.
An output projection layer that maps internal states to probability distributions over a vocabulary of musical events or audio tokens.

The server trains this model in advance using a large corpus of musical sequences and associated descriptive text. The server uses supervised learning with a loss function such as cross-entropy between predicted token distributions and ground-truth next tokens. The server performs gradient-based optimization (for example, stochastic gradient descent, Adam, or a variant) to update the weights. During training, the server may use data augmentation on the symbolic musical sequences (for example, key transposition or tempo scaling) to improve generalization. The server also may pre-train the model on generic text and then fine-tune on music-plus-text pairs, which helps the model to interpret prompt sentences more accurately.

During generation, the server uses decoding algorithms such as top-k sampling, nucleus sampling, or temperature-scaled sampling. The server adjusts decoding parameters based on the stimulation level encoded in the prompt sentence. For example, for “maximum” stimulation, the server may increase allowed rhythmic density and permit higher-energy patterns by biasing the probability of certain token subsets.

By structuring the prompt sentence and tying decoding parameters to specific fields (such as tempo or stimulation level), the server reduces the search space in token generation, thereby improving generation speed and reducing computational load. This structure also reduces the likelihood of mode collapse or unintentionally low-energy outputs, improving accuracy relative to the target arousal adjustment.

### D. Conversion From Structured Data to Audio and Technical Effects

The server receives from the generative AI model structured data for acoustic content, for example a symbolic event sequence describing note-on, note-off, velocity, instrument identifiers, and timing. The server uses a software synthesis mechanism, such as a software synthesizer with a sound font library, to convert these event sequences into digital audio signals.

The server applies an audio signal conversion mechanism to convert the synthesized audio into a standard format. The server controls sampling rate conversion, bit depth, channel configuration, and codec parameters. For example, the server generates linear PCM audio at a predetermined sampling rate, then encodes it into a compressed audio format using a psychoacoustic codec. The server stores the resulting compressed digital audio data in a storage device and provides a network-accessible resource identifier to the terminal.

This pipeline is designed for computational efficiency. Because the server generates structured symbolic data first, the payload between the generative AI model and the audio conversion subsystem is compact. The server can pre-allocate buffers and reuse synthesis sessions optimized for each content type. The separation of symbolic generation and audio rendering allows the server to cache often-used synthesis parameters for similar prompt sentences, reducing repeated initialization overhead and improving throughput for multiple users.

### E. Terminal-Side Control and Real-Time Adaptation

The terminal obtains the compressed digital audio data by requesting the resource identifier from the server via a communication protocol. The terminal uses a media playback framework (for example, a media playback library or an audio engine API) to decode the compressed data and stream it to the acoustic output unit. The terminal controls output level, playback start and stop timing, and optional fade-in and fade-out behaviors.

In some embodiments, the terminal displays a user interface allowing the user to provide feedback on the generated audio content. The terminal converts the feedback (for example, “very effective” or “not effective”) into evaluation information and transmits it to the server.

The terminal also may acquire operation information, such as volume adjustment frequency or playback interruption events, and biological information from connected sensors (for example, heart rate or motion data) during playback. The terminal transmits this information to the server as time-stamped records.

The server stores this feedback-related evaluation information in association with the original evaluation information and attribute information of the acoustic content. The server uses this data to update a decision logic module, which maps from arousal-related evaluation information to attribute information of acoustic content. The decision logic module may be implemented as a hybrid of:
Rule-based components (for example, threshold-based mappings from arousal score to stimulation level).
A learned mapping implemented as a smaller neural network or another statistical model, trained to predict which content types and parameters lead to effective arousal adjustment for specific user profiles.

By updating the decision logic, the server gradually improves the alignment between generated acoustic content and user responses. This adaptation is not a simple automation of human selection; rather, it leverages fine-grained feedback data in conjunction with structured prompt sentences to optimize content parameters in a way that would be difficult to perform manually in real time.

### F. Improvement of Computer Technology

The server improves computer technology in several concrete ways.

First, the server structures user state information and content attributes into prompt sentences with explicit fields. This constrains and conditions the generative AI model's operation in a way that reduces computational overhead and improves generation stability. The structured prompt design allows the server to reuse attention patterns and embedding representations for similar prompts, improving cache locality and reducing overall processing time.

Second, the server separates the generative model's symbolic output from the audio rendering pipeline, allowing independent scaling and optimization. This division reduces required bandwidth between the generative model (which may reside on a specialized hardware node) and the audio synthesis node, because symbolic sequences are more compact than raw audio. As a result, the system reduces network load and increases throughput, enabling multiple real-time generations simultaneously.

Third, by incorporating user feedback, operation information, and biological information into the decision logic and prompt configuration, the server builds an adaptive mapping that reduces the number of generation attempts needed to reach effective content for a given arousal state. This reduction in trial-and-error generations decreases computational resource consumption in the generative AI model and shortens end-to-end latency between state acquisition and effective playback.

Fourth, the server uses specific learning procedures for the generative AI model and the decision logic. For example, the server may model user response effectiveness as a target variable and apply gradient-based optimization to adjust weights that map from evaluation information to attribute information. The server may use a loss function that penalizes both misalignment with user feedback and excessive parameter changes, thereby achieving stable but adaptive behavior. Such training improves the precision of arousal-targeted generation beyond what simple rule-based or manual methods can provide.

Fifth, the use of structured, machine-readable prompt sentences allows the generative AI model to operate under controlled, repeatable conditions. This structure also simplifies logging and auditing: the server can index prompt sentences by discrete fields and correlate them with performance metrics. This data management improvement enables efficient offline analysis and retraining, thereby further enhancing computation efficiency and system reliability.

### G. Variations and Alternative Embodiments

In another embodiment, the server uses a recurrent neural network architecture such as a long short-term memory network instead of, or in combination with, a transformer architecture. In such a case, the server encodes the prompt sentence as an initial hidden state and generates tokens sequentially. The same structured prompt sentence format is used, and the technical effects of constrained generation and improved efficiency are maintained.

In yet another embodiment, the server uses a generative model that directly predicts audio tokens corresponding to a learned audio codec representation. The server then uses a specific decoder to convert the tokens into waveforms. Even in this direct-audio approach, the same structured prompt sentence and decision logic are applied, and the system still benefits from reduced prompt variability and improved decoding efficiency.

In a further embodiment, the terminal performs part of the generative processing locally. The server may transmit a compact representation of the prompt sentence and high-level generation parameters to the terminal. The terminal then runs a lightweight generative model to refine or extend the acoustic content. This offloading reduces server-side computation and network traffic while preserving the structured, feedback-driven control loop.

In yet another embodiment, the server aggregates feedback and state data from multiple users to train a global model for attribute decision logic, while also maintaining user-specific adjustment parameters. This hierarchical design improves generalization across users and allows the system to provide good performance even for new users with limited individual history.

Across these embodiments, the system does not merely automate human selection of music. Instead, the server and terminal implement a technically specific, structured, and adaptive pipeline that combines advanced generative AI modeling, explicit data structures, optimized conversion and transmission of audio data, and feedback-driven decision logic. This pipeline improves processing speed, accuracy of arousal targeting, data management, and computational efficiency in a way that is tied to the operation of the computer and the control of actual audio reproduction hardware in the real world.

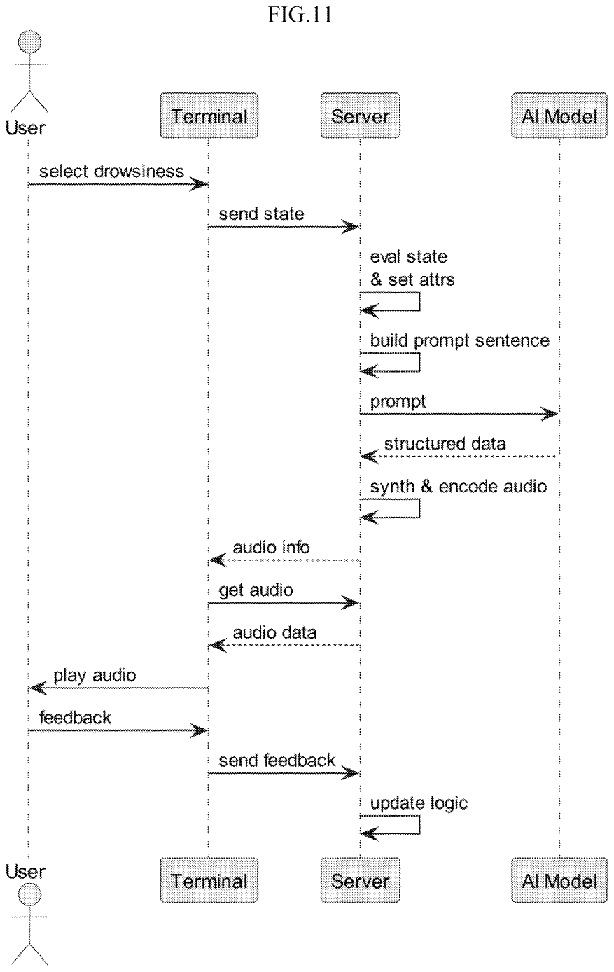

The following describes the processing flow using FIG. 11.

### Step 1

The terminal displays a state input screen to the user.

The terminal uses its display unit and graphical user interface framework to render selectable options indicating drowsiness levels (for example, “a little sleepy”, “sleepy”, “too sleepy”) and optionally other controls such as sliders or checkboxes.

Input: no external data; the terminal uses locally stored UI layout definitions.

Processing: the terminal loads UI resources from its storage and instantiates UI components in memory.

Output: a visible screen on the display that allows the user to select a drowsiness state and to confirm the selection.

### Step 2

The user selects a drowsiness state on the terminal.

The user touches the screen or operates hardware buttons to choose one of the displayed options and confirms the selection, for example by pressing a “Start” button.

Input: the user's physical interaction (touch coordinates, button presses).

Processing: the terminal's input subsystem converts the physical interaction into event data, maps the event data to the corresponding UI elements, and identifies the selected drowsiness level label.

Output: an internal representation of the user-selected drowsiness state (for example, a text label such as “too sleepy” and an associated code) stored in the terminal's working memory.

### Step 3

The terminal acquires optional sensor or operation data related to the user's arousal state.

The terminal may read data from built-in or connected sensors, such as accelerometers, cameras, microphones, or heart rate sensors, and may log recent interaction patterns such as frequent pausing or volume changes.

Input: raw sensor signals and recent operation logs.

Processing: the terminal's software converts raw sensor signals into numerical features (for example, average movement intensity, blink rate estimates, voice volume statistics) and normalizes them to a predefined range.

Output: a feature vector representing additional state information related to the user's arousal state.

### Step 4

The terminal constructs and sends a state information message to the server.

The terminal combines the user-selected drowsiness label and the optional feature vector into a structured message and transmits it over a network connection to the server.

Input: the selected drowsiness label and additional state features generated in Step 2 and Step 3.

Processing: the terminal serializes the data into a structured format, attaches metadata such as a timestamp and a user identifier, and sends the message via a communication protocol through the network interface.

Output: a network request received by the server that contains state information related to the user's arousal state.

### Step 5

The server receives and parses the state information from the terminal.

The server's network interface accepts the incoming request and forwards the payload to an application layer that handles state acquisition.

Input: the structured state information message from the terminal.

Processing: the server validates the message format, parses the drowsiness label, the feature vector, the timestamp, and the user identifier, and stores the parsed values in working memory.

Output: a normalized in-memory structure containing raw state information associated with the user session.

### Step 6

The server converts the state information into evaluation information indicating the degree of arousal.

The server applies a predefined mapping or small model to translate the raw state information into a numerical and categorical evaluation of the user's arousal level.

Input: the parsed drowsiness label and feature vector from Step 5.

Processing: the server maps each discrete label to a base arousal score, adjusts the score using sensor-derived features (for example, increasing the drowsiness score if movement is low and blink rate is high), and assigns a drowsiness class code. This computation may be implemented as a lookup combined with arithmetic operations or as a lightweight statistical model.

Output: evaluation information including at least a normalized arousal score, a drowsiness class code, and optional trend indicators.

### Step 7

The server determines attribute information of acoustic content based on the evaluation information.

The server uses decision logic to select a content type and a stimulation level that are appropriate for the evaluated arousal state.

Input: the evaluation information produced in Step 6.

Processing: the server applies rule-based thresholds or a learned mapping to the arousal score. For example, the server chooses an aggressive, high-energy content type and a maximum stimulation level for a high drowsiness score, or a moderate electronic style and medium stimulation level for a low drowsiness score. The server further computes parameters such as target tempo, target loudness, target duration, and rhythmic density using arithmetic formulas tied to the chosen stimulation level.

Output: attribute information including the content type, stimulation level, tempo range, loudness level, duration, and other acoustic parameters.

### Step 8

The server constructs a structured prompt sentence for the generative AI model.

The server encodes both the evaluation information and the attribute information into a text sequence formatted to condition the generative AI model.

Input: the evaluation information from Step 6 and the attribute information from Step 7.

Processing: the server concatenates fixed field labels and computed values into a multi-line textual prompt. The server arranges the fields in a predetermined order to stabilize the generative model's interpretation and ensures that all relevant parameters such as drowsiness state, target duration, genre, intensity, tempo, and loudness are explicitly described.

Output: a prompt sentence string that describes the desired acoustic content in a form suitable for input to the generative AI model.

### Step 9

The server sends the prompt sentence to the generative AI model and generates structured data for acoustic content.

The server invokes a generative AI model that interprets the prompt sentence and outputs symbolic or structured audio-related data.

Input: the prompt sentence created in Step 8.

Processing: the server tokenizes the prompt sentence, feeds the tokens into the generative model's input, and executes the model's inference process, which includes embedding lookup, multiple attention layers, and output projection. The model computes probability distributions over musical or audio tokens at each time step and samples or selects tokens according to a decoding strategy tuned by the stimulation level.

Output: structured data for acoustic content such as a sequence of symbolic events (for example, musical notes, durations, velocities, instrument identifiers) or audio tokens representing a time-series signal.

### Step 10

The server converts the structured data into digital audio data.

The server uses software synthesis and audio signal conversion mechanisms to transform the symbolic or token-based structured data into a standard digital audio format.

Input: the structured data output from the generative AI model in Step 9.

Processing: the server feeds event sequences into a software synthesizer, which generates linear PCM audio samples using digital signal processing algorithms. The server then applies an audio encoder to compress the PCM data using a selected codec, sets the sampling rate and bit rate, and packages the compressed data into an audio container format.

Output: compressed digital audio data stored on the server and a reference to the stored audio data, such as a file path or resource identifier.

### Step 11

The server stores and registers metadata for the generated digital audio data.

The server records the association between the generated audio and the underlying input conditions for future analysis and reuse.

Input: the compressed digital audio data and the related evaluation information, attribute information, and prompt sentence from previous steps.

Processing: the server writes the audio data to a storage device, creates a metadata record that includes user identifier, time of generation, evaluation information, attribute information, prompt sentence text, and storage location, and stores this record in a database.

Output: a persistent audio record and metadata entry that can be retrieved using the user identifier or session identifier.

### Step 12

The server prepares and sends a response message to the terminal with playback information.

The server provides the terminal with the necessary information to retrieve and play the generated audio.

Input: the audio storage location and metadata produced in Step 11.

Processing: the server constructs a response containing a resource identifier (for example, a URL or a token), the duration of the audio, and optional descriptive fields such as genre and intensity, then serializes this into a response message and transmits it through the network interface to the terminal.

Output: a response message received by the terminal that includes information required for audio retrieval and playback.

### Step 13

The terminal retrieves the compressed digital audio data from the server.

The terminal accesses the server-provided resource identifier and downloads or streams the associated audio data.

Input: the response message from Step 12 containing the resource identifier and duration.

Processing: the terminal sends a follow-up request to the provided resource identifier, receives the compressed audio in data packets, and writes the incoming data into a local buffer or temporary storage file.

Output: a locally stored or buffered compressed digital audio data file ready for decoding.

### Step 14

The terminal decodes and plays back the digital audio data for the user.

The terminal uses its audio playback framework to convert the compressed data to audio signals and output them through the acoustic output unit.

Input: the compressed digital audio data acquired in Step 13 and the playback duration information.

Processing: the terminal initializes a decoder for the audio format, decodes the compressed frames into PCM samples, and sends the samples to the audio subsystem at a controlled sampling rate. The terminal manages volume settings, playback start and stop timing, and optionally apply effects such as fade-in or fade-out.

Output: audible sound presented to the user that corresponds to the generated acoustic content, and internal playback status information such as current playback position.

### Step 15

The user listens to the presented acoustic content and optionally provides feedback.

The user experiences the generated music or sound and may respond using controls on the terminal.

Input: the audible output from Step 14 and the user's perception of its effectiveness.

Processing: the user operates feedback controls such as rating buttons, sliders, or comment fields. The user may indicate whether the content effectively reduced drowsiness or improved arousal.

Output: explicit feedback input events captured by the terminal.

### Step 16

The terminal collects feedback, operation information, and optional biological information during or after playback and sends these to the server.

The terminal aggregates all relevant response data and transmits it as a structured message.

Input: the user's feedback operations from Step 15, playback logs (for example, pauses, skips, volume changes), and any sensor-based biological information acquired during playback.

Processing: the terminal encodes these data into a feedback structure including identifiers for the related audio record and state information, adds timestamps, and sends the structure to the server via the network interface.

Output: a feedback message received by the server that links user response and interaction data to the previously generated acoustic content.

### Step 17

The server updates its decision logic and prompt configuration based on the received feedback.

The server uses feedback data to refine how it maps evaluation information to attribute information and how it constructs future prompt sentences.

Input: the feedback message from Step 16 and the stored metadata for the corresponding audio generation in Step 11.

Processing: the server associates the feedback with the original evaluation information, attribute information, and prompt sentence. The server then updates a rule set or trains parameters of a smaller decision model that predicts effective content parameters from evaluation information. This may include adjusting threshold values, weighting certain content types more strongly, or modifying how stimulation levels are mapped from arousal scores. The server records these updates so that future generations for the same user or similar evaluation information use improved attribute choices and prompt structures.

Output: an updated decision logic and prompt configuration stored on the server, which influence subsequent executions of Step 7 and Step 8.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional in-vehicle driver assistance systems typically rely on simple threshold-based sensors or static media playlists to address driver drowsiness. For example, systems may merely detect eye closure or steering behavior and then trigger a fixed alert sound or play a preselected piece of music. Such approaches suffer from several technical limitations.

First, they process limited input signals and do not robustly extract multi-dimensional features of the user's facial posture and eye behavior from time-series image data, which leads to inaccurate or unstable estimation of drowsiness levels. Second, even when a drowsiness level is detected, conventional systems do not dynamically generate content but rather select from a finite, pre-stored set of audio tracks, resulting in repetitive outputs that lose effectiveness over time and cannot be finely tuned to the user's current physiological state. Third, known systems do not provide a structured mechanism for expressing complex, context-dependent generation requirements to a generative AI model, and therefore cannot exploit such models to produce tailored audio content in real time.

From a computer-technology standpoint, existing systems do not adequately solve the problem of converting rich, time-varying sensor inputs into a machine-usable representation that can drive adaptive content generation. The processing pipeline from sensor acquisition, feature extraction, state classification, parameter selection, prompt construction, generative model invocation, and feedback-based adaptation is either fragmented or absent. As a result, computing resources are not efficiently used to maintain driver alertness, and the latency and quality of music generation are not optimized for real-time, safety-critical use.

There is therefore a need for an improved computer-implemented system that: (i) robustly detects and classifies user drowsiness levels from time-series sensor data using systematic feature extraction and classification, (ii) programmatically maps such drowsiness levels to structured music attribute parameters, (iii) automatically constructs precise prompt sentences in natural language together with machine-readable acoustic parameters for input to a generative AI model, and (iv) dynamically updates the generated music in response to changes in the user's state, thereby improving the operation of the underlying computing system and its ability to generate effective, context-aware audio content in real time.

The specific processing by the specific processing unit 290 of the data processing device 12 in Application Example 1 is realized by the following means.

The present invention provides a server comprising a processor configured to execute computer-implemented operations that include: acquiring time-series data from a detection apparatus that captures physiological or behavioral information of a user; performing image processing on the time-series data to detect a face region and an eye region of the user, and calculating feature values based on a posture of the face of the user and an opening and closing state of eyes of the user; classifying, by using the feature values, a drowsiness state of the user into a stage-wise drowsiness level; storing correspondence information between the drowsiness level and music attribute information including a type of music, a tempo, a sound volume, and an energy amount associated with each drowsiness level; determining, according to the classified drowsiness level, a genre of music and an intensity of the music from the music attribute information; generating, in a natural language, a prompt sentence including the determined genre and intensity, and further including a playback time, a tempo range, sound quality conditions, and conditions relating to a playback environment; inputting the prompt sentence and acoustic parameters into a generative information processing model to cause the generative information processing model to generate original music data; converting the generated music data into a predetermined audio format, and performing signal processing including loudness normalization and adjustment of a playback start position to generate playback audio data; and repeatedly re-evaluating the drowsiness level at predetermined time intervals and, when a change in the drowsiness level is detected, dynamically updating the music attribute information and the prompt sentence and re-executing a music generation process by the generative information processing model to switch the music data. This enables the computing system to transform rich sensor-derived representations of user state into structured control parameters and natural-language prompt sentences that drive a generative AI model, thereby improving the technical process of real-time, adaptive audio content generation, reducing reliance on static media resources, and enhancing the responsiveness, stability, and effectiveness of driver-awakening functions implemented by the server.

The term “time-series data” refers to data that is acquired at multiple time points in chronological order and that represents temporal changes in a measured quantity, such as sequences of image frames, sensor readings, or other continuously or intermittently sampled values.

The term “detection apparatus” refers to a hardware device or a combination of hardware and firmware that acquires physiological information or behavioral information of a user, including but not limited to cameras, optical sensors, inertial sensors, and biometric sensors installed in or near a vehicle cabin.

The term “physiological information” refers to information indicative of a physical state of a user's body, such as eye openness, facial muscle activity, heart rate, breathing pattern, or other biometric indicators.

The term “behavioral information” refers to information indicative of actions or movements of a user, such as head motion, gaze direction, facial expressions, or other observable behaviors captured by sensors.

The term “image processing” refers to computational operations performed on image data, including but not limited to decoding, resizing, color space conversion, filtering, feature detection, and region-of-interest extraction, to obtain useful information from the images.

The term “face region” refers to a subset of an image or frame that includes at least a portion of a user's face and that is identified by an image processing algorithm as corresponding to the user's face.

The term “eye region” refers to a subset of an image or frame that includes at least one of the user's eyes and that is identified within the face region by an image processing algorithm.

The term “feature values” refers to numerical values or vectors derived from processed data that quantitatively represent characteristics of the user or the image, such as eye aspect ratio, blink frequency, head pose angles, or other computed metrics.

The term “posture of the face” refers to an orientation or position of the user's head, including tilt, rotation, and nodding movements, as determined from the face region using pose estimation or landmark analysis.

The term “opening and closing state of eyes” refers to a condition describing how open or closed the user's eyes are, including intermediate states and dynamic changes such as blinks, as derived from measurements of the eye region.

The term “drowsiness state” refers to a condition indicative of a degree of sleepiness or reduced alertness of the user, inferred from physiological information, behavioral information, or combinations thereof.

The term “drowsiness level” refers to a discrete, stage-wise classification of the drowsiness state, such as slightly drowsy, drowsy, or very drowsy, that is produced by a classification process based on feature values.

The term “music attribute information” refers to structured data defining properties of music, including but not limited to a type or genre of music, a tempo, a sound volume level, and an energy amount or intensity.

The term “type of music” refers to a category or genre of music, such as rock, pop, electronic, or classical, used to characterize stylistic aspects of a generated audio track.

The term “tempo” refers to a speed of music, typically expressed as beats per minute or a range thereof, and used as a control parameter for music generation or playback.

The term “sound volume” refers to a playback loudness level or amplitude setting applied to audio output, which may be expressed as an absolute or relative value.

The term “energy amount” refers to an indicator of perceived intensity or vigor of music, which may be represented as a categorical level or a numeric value affecting rhythm strength, dynamic range, or instrumentation.

The term “genre of music” refers to a classification of music based on style, instrumentation, rhythm, and other musical characteristics, and may be determined as part of music attribute information.

The term “intensity of the music” refers to a level of strength or activation conveyed by a music track, including aspects such as dynamic range, density of sound events, and perceived excitement, which can be controlled as a parameter in music generation.

The term “prompt sentence” refers to a sequence of natural-language text that specifies conditions, requirements, or constraints for content generation, and that is provided as an input to a generative information processing model.

The term “natural language” refers to a human language, such as English or another spoken or written language, used to express the prompt sentence in a form interpretable by a generative information processing model.

The term “playback time” refers to a target duration for which generated music is intended to be reproduced, typically expressed in seconds or minutes.

The term “tempo range” refers to a lower limit and an upper limit of tempo values that define an allowable interval of speeds for the generated music.

The term “sound quality conditions” refers to constraints or target parameters related to audio fidelity, such as sampling rate, bit depth, number of channels, or compression characteristics.

The term “conditions relating to a playback environment” refers to specifications or constraints associated with a context in which audio is reproduced, including but not limited to an in-vehicle environment, ambient noise levels, or speaker configuration.

The term “acoustic parameters” refers to machine-readable control values related to generation or playback of audio, including but not limited to tempo, key, loudness, frequency response, and spatialization.

The term “generative information processing model” refers to a trained computational model that receives input information, including prompt sentences and parameters, and outputs newly generated data, such as original music data, based on learned patterns.

The term “original music data” refers to audio data representing a newly generated music sequence that is not a direct copy of pre-stored music, and that is produced by a generative information processing model in response to input conditions.

The term “audio format” refers to a structured representation of digital audio data, such as a particular file type or encoding scheme, that defines how samples are arranged and stored.

The term “signal processing” refers to algorithmic operations performed on audio data, including but not limited to filtering, normalization, time alignment, and format conversion, to modify or prepare the data for playback.

The term “loudness normalization” refers to a process of adjusting levels of audio data so that perceived loudness is maintained within a target range or matched across different audio segments.

The term “playback start position” refers to a temporal point within an audio track at which reproduction begins, which may be adjusted to control user perception or to synchronize with other events.

The term “playback audio data” refers to processed audio data that has been converted and conditioned to be directly usable by an output device for reproduction as sound.

The term “acoustic output system” refers to a combination of hardware and control components used to reproduce audio, including amplifiers, speakers, and associated interfaces.

The term “acoustic output apparatus” refers to a hardware device, such as a loudspeaker or a set of loudspeakers, that converts electrical or digital audio signals into audible sound.

The term “vehicle” refers to a transportation apparatus, such as an automobile or similar conveyance, in which the user is located and in which the acoustic output apparatus and detection apparatus may be installed.

The term “playback sound volume” refers to an applied level of gain or attenuation for audio signals during reproduction, controlling how loud the sound is perceived by the user.

The term “playback timing” refers to temporal control of when audio playback starts, stops, or changes, including synchronization with events such as changes in drowsiness level.

The term “user attribute information” refers to stored data representing user-specific preferences or constraints, including allowable types of music, tempo ranges, and upper limits of sound volume.

The term “operation input” refers to input commands or settings provided by the user through an input interface, such as buttons, touch screens, or voice commands, that influence system behavior.

The term “preference information” refers to information indicating a user's likes or dislikes regarding content, such as favored genres, disliked styles, or acceptable loudness levels.

The term “allowable types of music” refers to music categories that are permitted for generation or playback for a particular user, as specified in user attribute information.

The term “allowable tempo range” refers to a tempo interval that is acceptable for a particular user or context, beyond which tempo values are not to be used for generation or playback.

The term “upper limit of sound volume” refers to a maximum volume level defined for a user or environment, beyond which audio should not be reproduced to avoid discomfort or risk.

The term “correct the music attribute information and the prompt sentence” refers to modifying parameters and textual descriptions used for content generation in accordance with user attribute information, so that generated music conforms to user-specific constraints.

The term “music generation result” refers to an output of the generative information processing model, including generated music data and its associated attributes, obtained based on a given prompt sentence and parameters.

In one embodiment, a server cooperates with at least one terminal installed in a vehicle to implement the claimed system. The server includes a processor, a memory storing executable instructions and data structures, and a communication interface connected to a network. The terminal includes a processor, a memory, a display, an audio output apparatus integrated into an in-vehicle acoustic output system, and a communication interface. A detection apparatus, such as a vehicle-mounted camera and additional sensors, is connected to the server and/or the terminal via a vehicle bus or a local interface.

The server uses hardware such as a central processing unit and, in some cases, an accelerator such as a graphics processing unit. The server executes software components including an operating system, an image processing library corresponding to an image analysis toolkit, a numerical computation library, and an audio processing library corresponding to a multimedia processing toolkit. The server optionally executes a machine learning framework, such as a neural network runtime, to implement classification and generative inference. The terminal executes an embedded operating system, an audio playback framework, and a communication stack.

The server receives time-series data from the detection apparatus. In one form, the detection apparatus is a camera installed in the vehicle cabin that continuously captures image frames of the user's face at a fixed frame rate. The server uses an image processing library to decode the camera stream, convert the frames into a uniform color space, and normalize resolution and brightness. The server stores the resulting image frames in a ring buffer in memory, thereby maintaining a fixed-length history of recent images for temporal analysis.

The server applies a face detection algorithm to each frame. The server uses either a cascade classifier trained on face patterns or a deep neural network for object detection, depending on available computational resources. In a cascade-based variant, the server loads a set of cascaded classifiers, scans the image at multiple scales, and selects the most confident bounding box corresponding to the driver's face. In a neural-network-based variant, the server uses a convolutional neural network with multiple convolutional layers, activation layers, and pooling layers to produce bounding boxes and confidence scores, and discards detections below a threshold. The server then extracts a face region from the frame.

The server detects eye regions within the face region. The server uses an eye detector or a facial landmark detector that outputs positions of key points, such as corners of the eyes and eyelids. The server calculates an eye aspect ratio for each eye by computing a ratio of distances between selected landmark points. The server maintains a sequence of eye aspect ratio values across the time-series buffer. The server computes derived feature values, such as average eye openness over a sliding window, count of blinks per minute, and duration of eye closure longer than a specified threshold.

The server estimates a posture of the face by using facial landmarks and a head pose estimation algorithm. The server models the face as a set of three-dimensional reference points and applies a pose estimation function that solves for rotation and translation parameters relative to the camera. The server thereby obtains pitch, yaw, and roll angles of the head for each frame. The server aggregates these angles over time and computes additional feature values, such as frequency of nodding motions, average downward tilt, and variance of head orientation.

The server combines the eye-related feature values and the head posture feature values into a feature vector for each analysis window. The server stores these feature vectors in a time-indexed data structure and provides them to a classification module. In one embodiment, the server uses a trained neural network classifier. The classifier can be a feed-forward network with an input layer receiving the feature vector, one or more hidden layers with non-linear activation functions, and an output layer providing a probability distribution over discrete drowsiness levels. The server trains this classifier offline using labeled training data that includes recorded camera sequences and corresponding human-annotated drowsiness levels. During training, the server uses a loss function such as cross-entropy and updates network weights by stochastic gradient descent or a variant thereof, optionally with regularization and data augmentation techniques such as simulated lighting changes and viewpoint shifts to improve robustness.

At runtime, the server inputs each feature vector into the trained classifier, receives probabilities for each possible drowsiness level, and determines a current drowsiness level by selecting the level with highest probability or by applying a threshold-based decision rule. To improve stability, the server applies temporal smoothing, such as an exponential moving average over successive predictions, to reduce spurious fluctuations caused by noise.

The server stores a mapping between each drowsiness level and music attribute information. The music attribute information includes a type of music, a tempo or tempo range, a sound volume profile, and an energy level. The server represents this mapping as a structured table in memory. For example, the table associates a “very sleepy” level with an intense genre, a high tempo range, maximum energy, and a high target sound volume, whereas a “slightly sleepy” level is associated with a lighter genre, a moderate tempo range, and a moderate energy level. The server retrieves the row corresponding to the current drowsiness level and extracts the music attribute information.

The server constructs a prompt sentence for a generative AI model. The server uses a template in which placeholders for drowsiness level, genre, intensity, tempo range, target playback time, and playback environment are filled with values derived from the music attribute information and system settings. The server thereby generates a natural-language description specifying what kind of music is required in the current context. The server also prepares acoustic parameters, such as desired sample rate, number of channels, and target loudness.

In one concrete example, when the classifier indicates that the user is at a “very sleepy” level, the server generates the following prompt sentence:
“The user is in a ‘very sleepy’ state while driving. Please generate music that strongly awakens the driver. The genre should be intense rock with maximum intensity, a fast tempo around 160 BPM, strong percussion, and powerful melodies. The length should be about 3 minutes, stereo, 44.1 kHz.”

In another example, when the user is at a “sleepy” level, the server generates:
“The user is in a ‘sleepy’ state while driving. Please generate music that helps the driver stay alert without causing stress. The genre should be upbeat electronic dance music, with medium-high intensity. Use a tempo around 130 BPM, a steady rhythm, and bright synth sounds. The length should be about 2 minutes, stereo, 44.1 kHz.”

The server transmits the prompt sentence and the acoustic parameters to a generative AI model. In one embodiment, the generative AI model is a neural network for music generation deployed on the server or on a remote computing resource. The generative AI model can be implemented as a sequence-to-sequence architecture or a diffusion-based audio generator. For example, the server uses a model comprising an encoder that embeds the prompt sentence into a latent representation, a conditioning module that incorporates acoustic parameters, and a decoder that synthesizes audio waveforms. The model may be trained offline on a large collection of music data and associated textual descriptions, using a loss function that combines reconstruction loss in the waveform domain and perceptual loss in a learned feature space. During training, the server performs mini-batch optimization, updates weights by backpropagation, and uses regularization and curriculum strategies to stabilize training.

During inference, the server encodes the prompt sentence, projects it into a latent control vector, and passes the vector and acoustic parameters into the generative core. The generative core produces a sequence of audio samples in a streaming fashion or as a complete segment. The server receives this sequence and stores it as music data in a buffer. The server measures the loudness of the generated audio and applies loudness normalization so that the resulting playback audio data falls within a target range, improving consistency between different generated segments.

The server converts the music data into a predetermined audio format, such as a compressed format supported by the terminal. The server uses an audio processing library to perform format conversion, resampling, and channel mixing, if required. The server further adjusts a playback start position, for example by avoiding initial silence or transient artifacts, and aligns the segment boundaries to allow smooth transitions when future segments are generated.

The terminal receives the playback audio data from the server through a communication network. The terminal buffers the data in memory and invokes its audio playback framework to reproduce the sound via the in-vehicle acoustic output system. The terminal applies playback sound volume and equalization settings in accordance with control information provided by the server, such as the intensity level associated with the current drowsiness level. The terminal may also present on its display information indicating that a drowsiness-adaptive music mode is active.

The server periodically re-evaluates the drowsiness level by repeating feature extraction and classification on newly acquired image data. When the server detects a change in the drowsiness level that exceeds a predetermined threshold, the server updates the selected music attribute information, reconstructs a prompt sentence reflecting the new level, and initiates a new generation process at the generative AI model. The server may control the timing of switching between old and new music segments, such as by instructing the terminal to perform a crossfade between audio streams, thereby reducing perceptible discontinuities.

In order to incorporate user preferences, the server stores user attribute information indicating allowable types of music, an allowable tempo range, and an upper limit of sound volume. The terminal acquires this information from user operation input or from a configuration interface and transmits it to the server. The server modifies the music attribute information and the prompt sentence in view of the user attribute information, for example by excluding certain genres or by clamping the tempo and volume values within user-defined limits. The server thereby adapts the generated music to each individual user while maintaining the relationship between drowsiness level and energy of the music.

From a technical standpoint, the described structure improves computer performance in several ways. The server uses compact feature vectors derived from raw image data instead of transmitting or storing complete video streams for classification, which reduces memory usage and communication bandwidth. The classification based on precomputed feature values and a trained neural network yields low-latency drowsiness estimation, suitable for real-time control of music generation. The explicit mapping from drowsiness level to structured music attribute information simplifies parameter selection and avoids repeated complex reasoning at runtime, contributing to faster decision-making and deterministic behavior.

The server also improves efficiency of the generative AI model. By constructing precise prompt sentences and providing explicit acoustic parameters, the server constrains the generative search space, reducing computational overhead required for inference and increasing the likelihood that a single generation pass produces acceptable audio. The server's signal processing pipeline normalizes loudness and aligns segment boundaries, reducing the need for repeated regeneration due to poor audio quality or misaligned transitions. These technical structures lead to overall reductions in processing time, latency, and model invocation overhead compared to naive approaches that repeatedly generate content with vague or underspecified prompts.

The system further exhibits technical improvements in safety and control of physical equipment. The server directly influences operation of the in-vehicle acoustic output system through the terminal by selecting content characteristics and playback parameters in response to computed drowsiness levels. Because the drowsiness levels are computed from complex feature vectors that incorporate both eye information and head posture, the system can more accurately distinguish between transient blinks and sustained drowsiness. This higher precision reduces false positives and false negatives, allowing the system to trigger strong audio stimulation only when truly needed, thereby minimizing unnecessary noise and user distraction.

The described use of a generative AI model also differs from mere automation of human tasks. Human operators cannot generate, in real time and with consistent energy profiles, large volumes of tailored music segments that precisely match a machine-computed drowsiness level and adapt every few seconds based on subtle changes in eye and head metrics. The server exploits the generative AI model as a computational component that transforms structured feature-derived instructions into waveform data using a trained neural network with thousands or millions of parameters. The training procedure, loss functions, and weight updates define non-intuitive internal representations that are not equivalent to simple human heuristics. The server's orchestration of feature extraction, classification, mapping, prompt construction, and generative inference thus constitutes an improvement in how computers process sensor data and generate control signals for physical devices.

Alternative embodiments are possible within this framework. In one alternative, the server executes a recurrent neural network or a temporal convolutional network that directly ingests sequences of feature vectors and outputs drowsiness levels, thereby incorporating temporal dependencies in a different manner. In another alternative, the generative AI model is implemented as a diffusion-based model that iteratively refines a noise signal into a music waveform under the guidance of an embedding derived from the prompt sentence. In a further variation, the terminal performs part of the feature extraction and classification locally, transmitting only the detected drowsiness level and user attribute information to the server, thereby reducing network traffic; in this case, the server still performs mapping, prompt generation, and interaction with the generative AI model.

In another embodiment, additional sensors, such as steering wheel torque sensors or seat pressure sensors, provide supplementary behavioral information. The server fuses this information with image-based feature values into an extended feature vector, which may improve classification accuracy under difficult lighting or occlusion conditions. The same mapping and generative pipeline is then applied. In yet another embodiment, the server uses a rule-based component in conjunction with the neural classifier to enforce safety policies, such as limiting maximum sound volume at night or when long-term drowsiness indicators exceed a threshold.

Through these embodiments, the server, the terminal, and the detection apparatus cooperate to implement a concrete hardware-software system that transforms rich, time-varying sensor data into adaptive control of an in-vehicle audio output system via a generative AI model. The system thus provides a specific technological solution that improves computer-based detection, decision, and content generation processes, and yields measurable technical effects such as increased detection accuracy, reduced latency, improved resource utilization, and more effective control of physical audio equipment in a vehicle environment.

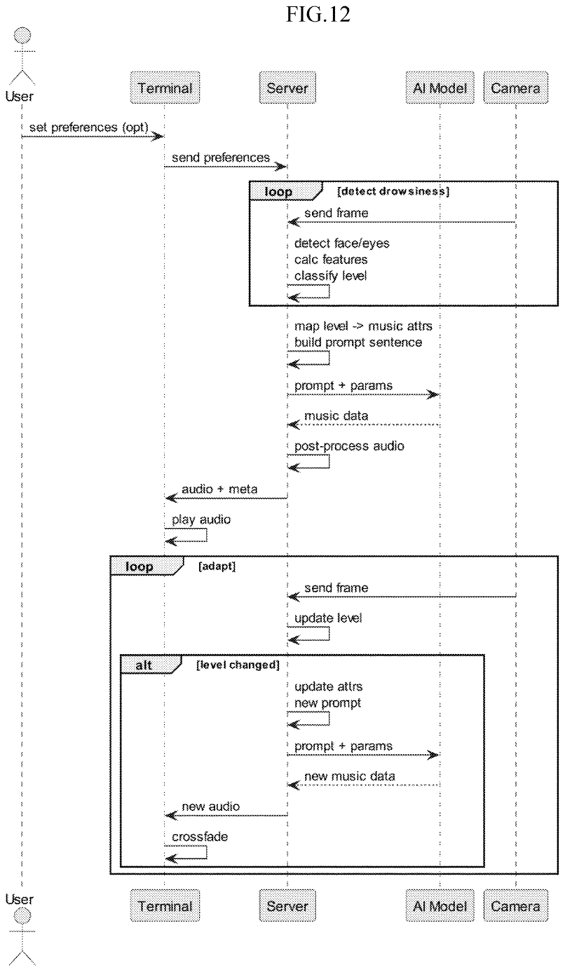

The following describes the processing flow using FIG. 12.

### Step 1

The server acquires time-series sensor data from the detection apparatus.

The server receives, as input, raw image frames captured by a camera installed in the vehicle cabin and optionally additional sensor values such as head position or illumination level. The server decodes the video stream, converts frames to a unified color space (for example, grayscale), and resizes them to a fixed resolution. Based on these input frames, the server performs normalization of brightness and contrast using image processing operations and stores the resulting preprocessed frames in a time-indexed buffer. The output of this step is a sequence of preprocessed image frames suitable for further analysis.

### Step 2

The server detects a face region and an eye region of the user from the preprocessed frames.

The server takes, as input, the preprocessed image frames from Step 1. The server applies a face detection algorithm, such as a cascade classifier or a convolutional neural network, to locate a bounding box corresponding to the user's face in each frame. The server then crops the face region and applies an eye detection or landmark detection algorithm to identify regions corresponding to the left and right eyes. Using coordinate calculations, the server generates bounding boxes and landmark points for eyes within the face region. The output of this step is a set of face and eye regions, represented as coordinates and landmarks associated with each frame.

### Step 3

The server calculates feature values related to eye openness and head posture.

The server uses, as input, the eye and face landmarks from Step 2. The server computes an eye aspect ratio for each eye by calculating distances between upper and lower eyelid landmarks and forming a ratio that reflects eye opening. The server tracks these values over time to determine blink frequency, average eye openness, and durations of prolonged eye closure. The server also applies a head pose estimation algorithm to the face landmarks, computing pitch, yaw, and roll angles of the head. From these angles, the server derives feature values such as average head tilt, nodding frequency, and variance of head orientation. The output of this step is a feature vector for each time window, containing numeric descriptors of eye behavior and head posture.

### Step 4

The server classifies the drowsiness level of the user based on the feature values.

The server takes, as input, the feature vectors generated in Step 3. The server passes each feature vector into a trained classifier, such as a neural network with one or more hidden layers or a decision-tree-based model. The classifier computes weighted sums of the feature values, applies non-linear activation functions, and outputs probabilities for multiple discrete drowsiness levels, such as “slightly drowsy,” “drowsy,” and “very drowsy.” The server selects the drowsiness level with the highest probability and applies temporal smoothing by averaging or filtering the last several predictions to reduce noise. The output of this step is a stabilized drowsiness level label and an associated confidence value.

### Step 5

The server determines music attribute information corresponding to the drowsiness level.

The server receives, as input, the current drowsiness level from Step 4. The server accesses a stored mapping table that associates each drowsiness level with music attributes, including music type, tempo or tempo range, target sound volume, and energy level. The server retrieves the row matching the current drowsiness level and extracts values such as a target genre (for example, intense rock or electronic dance), a tempo range (for example, 150-170 BPM), and an intensity level (for example, maximum). Based on these values, the server generates a structured music attribute record that will control subsequent generation. The output of this step is a music attribute record aligned with the detected drowsiness level.

### Step 6

The server constructs a prompt sentence for a generative AI model.

The server uses, as input, the music attribute record from Step 5 and system configuration parameters such as desired playback time, sound quality conditions, and playback environment (for example, in-vehicle use). The server fills in a natural-language template with the current drowsiness level, selected genre, intensity, tempo range, and target duration. The server also appends acoustic requirements such as stereo format and sampling rate. For instance, when the drowsiness level is “very drowsy,” the server creates a prompt sentence such as:
“The user is in a ‘very sleepy’ state while driving. Please generate music that strongly awakens the driver. The genre should be intense rock with maximum intensity, a fast tempo around 160 BPM, strong percussion, and powerful melodies. The length should be about 3 minutes, stereo, 44.1 kHz.”

The output of this step is a text-based prompt sentence and a set of acoustic parameters ready for input to the generative AI model.

### Step 7

The server generates original music data using the generative AI model.

The server takes, as input, the prompt sentence and acoustic parameters from Step 6. The server sends these inputs to a generative AI model implemented as a trained neural network for music generation. Internally, the model encodes the text prompt into a latent representation, combines it with the acoustic parameters, and iteratively computes audio samples by propagating signals through multiple network layers or diffusion steps. The server receives the generated audio signal from the model as a sequence of digital samples or an audio file. The server stores this data in a buffer in memory. The output of this step is raw generated music data that reflects the requested style, tempo, and intensity.

### Step 8

The server converts and post-processes the generated music data into playback audio data.

The server uses, as input, the raw generated music data from Step 7. The server applies signal processing operations, including resampling to a target sampling rate, conversion into a target audio format such as a compressed file type, and channel mixing to match the speaker configuration. The server analyzes the loudness of the audio and performs loudness normalization by scaling sample amplitudes so that the perceived volume falls within a specified range. The server also adjusts the playback start position, for example by removing initial silence or transient noise. The output of this step is playback audio data in a predetermined format suitable for consumption by the terminal.

### Step 9

The server transmits the playback audio data and control information to the terminal.

The server receives, as input, the playback audio data from Step 8 and the associated control parameters such as intensity level and recommended volume. The server segments the audio data into packets or chunks and sends them to the terminal via a communication interface, using a protocol that supports streaming. The server includes metadata describing the genre, tempo, and suggested volume so that the terminal can adjust playback behavior. The output of this step is a data stream delivered to the terminal and synchronized control information describing how the audio should be reproduced.

### Step 10

The terminal plays back the received audio data through the in-vehicle acoustic output system.

The terminal takes, as input, the audio data packets and metadata from the server in Step 9. The terminal buffers incoming audio in its memory, decodes the audio format if necessary, and sends the decoded samples to its audio playback framework. The terminal adjusts the playback volume and, if applicable, equalizer settings in accordance with the intensity level and drowsiness level contained in the metadata. The terminal then outputs the audio through the vehicle's speakers, causing the user to hear generated music that is tailored to the detected drowsiness state. The output of this step is audible sound in the vehicle cabin.

### Step 11

The server performs continuous monitoring and adaptive regeneration of music.

The server receives, as input, updated preprocessed frames from the detection apparatus and, optionally, feedback from the terminal about current playback status. The server repeats Steps 2 through 4 to compute updated feature values and drowsiness levels. When the server detects that the drowsiness level has changed beyond a predefined threshold, the server re-enters Steps 5 through 8 to determine new music attributes, construct an updated prompt sentence, and generate new music data. The server then instructs the terminal to switch to or crossfade into the newly generated playback audio data. The output of this step is an updated stream of music and control instructions that track the user's evolving drowsiness level.

### Step 12

The user optionally provides preference input that influences later processing.

The user provides, as input, configuration commands via the terminal, such as preferred genres, disallowed music types, acceptable tempo ranges, and maximum volume. The terminal collects this information and sends it to the server as user attribute information. The server merges these preferences with the mapping table used in Step 5 and the template used in Step 6, modifying selected genres, tempo ranges, and volume limits accordingly. The output of this step is an updated set of user-specific constraints that the server applies in future iterations of music attribute selection and prompt sentence construction.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented music recommendation and playback systems generally map coarse user states, such as “tired” or “awake,” to fixed playlists or pre-produced audio content using static rule sets. In such systems, the computing device merely retrieves and streams existing media files. As a result, the underlying computer architecture, including processors, memories, and communication interfaces, is not leveraged to dynamically reconfigure media content or the control logic of a content generation engine based on fine-grained user state information and accumulated usage history. This leads to several technical limitations in terms of how efficiently and adaptively the computing system can process state information, generate content, and manage resources.

First, in conventional systems, user state information is not transformed into a structured, machine-actionable specification for content generation. The user state is often processed as a simple label that directly selects one of a small number of pre-defined media assets. The processor does not generate a detailed, parameterized description of desired media characteristics, such as intensity, tempo, or duration, expressed in a form optimized for input to a generative model. Consequently, the system's internal data flow, from user input through content generation to delivery, remains coarse and inflexible, resulting in inefficient use of computation and limited adaptability of the content generation pipeline.

Second, existing generative content systems that do accept natural language prompts typically treat prompt generation as a manual or external step, and do not implement a closed-loop mechanism on the server side that (i) programmatically constructs prompt sentences based on structured state data, (ii) processes outputs from a generative AI model, and (iii) automatically refines future prompt generation logic using feedback. In such architectures, the server behaves as a passive relay rather than an active controller that optimizes the generative AI pipeline. This limits the ability of the processor to control and adapt the generative AI model as a computational resource and prevents the system from improving the technical behavior of the model invocation over time.

Third, conventional systems often handle generated media content as static files without integrating systematic post-processing, storage, and retrieval mechanisms tailored to the characteristics of generated audio. For example, the server may not perform automated duration control, volume normalization, encoding format conversion, or metadata management in a coordinated manner. As a result, client devices may receive audio content with inconsistent length, loudness, or format, which increases decoding and buffering overhead on the client side, reduces playback stability, and leads to suboptimal utilization of network and storage resources.

Fourth, many systems do not maintain structured history information that links user state information, generation parameters, generated content, and feedback in a unified data model. Without such history data, the processor cannot effectively update the mapping between user states and content generation conditions. This prevents the system from improving its internal decision rules or numerical parameters and from modifying prompt generation in a way that technically optimizes performance of the overall architecture, including latency, success rate of user-state-specific awakening, and resource consumption of the generative AI model.

Accordingly, there is a need for an improved computer-implemented system in which a processor (i) converts user-selected drowsiness state information into detailed music generation conditions, (ii) automatically generates a structured prompt sentence in natural language suitable for a generative AI model, (iii) controls a generative AI model to output machine-readable music data, (iv) executes integrated audio signal processing and storage operations on the server side, and (v) maintains and exploits history information including user feedback to adaptively update the mapping from state information to music generation conditions. By organizing these operations into a coordinated processing pipeline under control of the processor, the invention aims to improve the functioning of the computer system itself, including more efficient use of a generative AI model, more predictable and optimized audio outputs, and an adaptive control loop that refines future prompt generation and content processing.

The specific processing by the specific processing unit 290 of the data processing device 12 in Example 2 is realized by the following means.

The present invention provides a server comprising a processor and a memory storing instructions which, when executed by the processor, cause the processor to receive, via a communication interface, state information indicating a level of drowsiness of a user, the state information having been selected by the user through an input apparatus; to determine, based on the received state information, music generation conditions including at least a type of sound content, an intensity of the sound content, a tempo of the sound content, and a playback duration of the sound content; to convert the determined music generation conditions into a prompt sentence represented as text information including natural language, the prompt sentence being configured as an input specification for a generative AI model; to input the prompt sentence to the generative AI model and acquire, from the generative AI model, music data representing the sound content as encoded data or control data; to perform audio signal processing on the acquired music data, the audio signal processing including at least one of a duration adjustment process, a volume normalization process, an encoding format conversion process, and a metadata addition process, to generate processed music data; to store the processed music data in a storage apparatus and to transmit, to the input apparatus, response information including retrieval identification information for the processed music data; and to store, in the memory or in an associated storage unit, history information including at least the state information, the music generation conditions, and response information from the user regarding the processed music data, and to update, based on the history information, a correspondence relationship between the state information and the music generation conditions so as to adaptively change contents of a subsequently generated prompt sentence. This enables the server to implement a closed-loop control architecture in which the processor automatically translates coarse user state inputs into detailed, machine-actionable prompt sentences for a generative AI model, executes integrated post-processing and storage of generated music data, and iteratively refines the mapping from user state to generation conditions based on accumulated history, thereby improving the technical performance, resource efficiency, and adaptability of the computer system that generates and delivers audio content.

The term “processor” refers to a hardware computation unit or a combination of hardware computation units, such as a central processing unit or a graphics processing unit, that executes instructions to perform arithmetic, logical, control, and input/output operations.

The term “memory” refers to a hardware storage medium, such as volatile memory or non-volatile memory, that stores instructions and data to be read, written, and processed by a processor.

The term “communication interface” refers to a hardware and software subsystem that enables data exchange between the server and external devices or networks, including wired and wireless communication modules and associated protocols.

The term “input apparatus” refers to any terminal device or user interface device, such as a portable communication device, a computing device, or a display with an input sensor, through which a user can input information to the system.

The term “state information” refers to data representing a condition of a user, including at least a level of drowsiness or alertness, which is selected or otherwise provided by the user to the system.

The term “level of drowsiness” refers to a degree or category of a user's sleepiness or reduced alertness, expressed as one of a plurality of discrete levels or as a numerical value corresponding to such levels.

The term “music generation conditions” refers to one or more parameters for generating sound content, including at least a type of sound content, an intensity of the sound content, a tempo of the sound content, and a playback duration of the sound content.

The term “type of sound content” refers to a category or style of audio, such as a musical genre, timbral profile, or structural pattern, that characterizes the generated sound content.

The term “intensity of the sound content” refers to a measure of the strength, energy, or stimulation level of the generated sound content, which may be represented as a discrete level or a numerical value.

The term “tempo of the sound content” refers to a rate of progression of the generated sound content, such as beats per minute, that indicates the speed of musical events.

The term “playback duration of the sound content” refers to a target or actual time length during which the generated sound content is intended to be reproduced.

The term “prompt sentence” refers to text information including natural language that encodes the music generation conditions and is formatted as an input specification suitable for controlling a generative AI model.

The term “generative AI model” refers to a machine learning model, such as a neural network model, configured to generate new data, including at least music data or audio data, in response to input information such as a prompt sentence.

The term “music data” refers to digital data representing sound content, including encoded audio data, symbolic control data such as musical event information, or any combination thereof.

The term “encoded data” refers to data representing audio signals that have been compressed or formatted according to a predetermined encoding scheme or file format suitable for storage or transmission.

The term “control data” refers to symbolic or parametric data representing control information for sound generation, including note events, timing information, dynamics, and other parameters used by a sound synthesis engine.

The term “audio signal processing” refers to processing operations applied to music data or audio data, including at least duration adjustment, volume normalization, encoding format conversion, and metadata addition.

The term “duration adjustment process” refers to an operation that modifies the time length of music data or audio data, including trimming, extending, looping, or time-scaling the content.

The term “volume normalization process” refers to an operation that adjusts amplitude levels of audio data so that the loudness of the content conforms to a target level or range.

The term “encoding format conversion process” refers to an operation that transforms music data from a first encoding format or file type into a second encoding format or file type.

The term “metadata addition process” refers to an operation that appends or embeds descriptive information, such as title, category, or parameter values, into or in association with the music data.

The term “processed music data” refers to music data that has undergone at least one audio signal processing operation, including duration adjustment, volume normalization, encoding format conversion, or metadata addition.

The term “storage apparatus” refers to a hardware storage device or system, such as a local storage device, a network storage device, or a cloud storage service, that stores music data, processed music data, or other information.

The term “response information” refers to information transmitted from the server toward the input apparatus, including at least retrieval identification information that enables the input apparatus to obtain corresponding processed music data.

The term “retrieval identification information” refers to data, such as an identifier, a uniform resource locator, or a token, that specifies a stored item of processed music data and allows that item to be retrieved from a storage apparatus.

The term “history information” refers to stored information that associates at least state information, music generation conditions, generated music data or processed music data, and response information from a user.

The term “response information from the user” refers to information indicating a reaction, evaluation, or feedback of the user regarding generated music data or processed music data, including at least an indication of perceived effectiveness in reducing drowsiness.

The term “correspondence relationship between the state information and the music generation conditions” refers to a mapping, rule set, or parameter set that specifies how particular state information values are associated with particular music generation conditions.

The term “evaluation information” refers to data that indicates an assessment by the user or by the system of the effect or suitability of the processed music data, including measures related to change in drowsiness or user satisfaction.

The term “rule” refers to a logical condition, mapping entry, or decision criterion used by the processor to determine music generation conditions from state information or from history information.

The term “numerical parameter” refers to a numerical value, weight, threshold, coefficient, or other quantitative quantity used by the processor when determining music generation conditions or updating the correspondence relationship.

The term “closed-loop control architecture” refers to a configuration in which outputs of the system, including user responses and evaluation information, are fed back as inputs for updating internal mappings, rules, or parameters so as to influence subsequent processing.

In one embodiment, a server cooperates with a terminal operated by a user to generate and deliver audio content that is adaptively tailored to a drowsiness level of the user.

The server includes at least one processor, a memory storing executable instructions and data, a communication interface connected to a communication network, and a storage apparatus.

The terminal includes at least one processor, a memory, a display apparatus, an input apparatus such as a touch panel, a communication module, and an audio output apparatus such as a loudspeaker or a headphone interface.

The terminal presents, on the display apparatus, a graphical user interface that allows the user to select a level of drowsiness. The terminal may use a mobile operating system framework such as an iOS framework or an Android framework to draw selectable elements representing discrete drowsiness levels, for example “a little sleepy,” “sleepy,” and “very sleepy.” The user operates the input apparatus, such as touching one of the displayed elements, so that the terminal acquires input that specifies the drowsiness level. The terminal converts the selected item into structured state information, for example an internal code and a numerical value, and stores the state information in the memory as a data structure that includes at least a field for a user identifier and a field for a drowsiness code.

The terminal transmits the state information to the server via the communication interface.

The terminal may construct a request using a communication library and encapsulate the state information in a message body. The terminal may further add device information and time information. The terminal sends this message to the server through a wireless or wired communication network so that the server can receive the state information with low latency and high reliability.

The server receives the state information and stores the state information in the memory as part of an internal data structure that may include fields such as a session identifier, a user identifier, a drowsiness code, a time stamp, and a processing status flag. The server uses a database management system, such as a relational database system, to persistently store the state information as history information so that the server can later access the state information when updating mapping rules or numerical parameters.

The server converts the state information into music generation conditions. The server maintains a mapping function in the memory that associates each drowsiness code with a set of music generation parameters. The mapping function may be represented as a lookup table, a decision tree, or a parametric function. For example, the server may associate a “medium” drowsiness level with a pop-like sound type, a medium intensity, a tempo around 120 beats per minute, and a playback duration around 180 seconds. The server may associate a “high” drowsiness level with an energetic electronic sound type, a high intensity, a tempo around 138 beats per minute, and a similar duration. The server may additionally determine parameters such as rhythmic complexity, spectral brightness, dynamic range, and expected loudness level. These parameters are stored as part of the music generation conditions in a structured record.

The server generates a prompt sentence for a generative AI model based on the music generation conditions. The server stores, in the memory, a template for the prompt sentence that includes placeholders for a description of the user's drowsiness state, a description of the type of sound content, an intensity description, a tempo description, and a duration description. The server fills the placeholders using the music generation conditions and converts numerical values into human-readable text strings. The server thereby produces a prompt sentence that describes the desired audio content in natural language and that is optimized for the generative AI model. For example, when the drowsiness level is “sleepy,” the server may generate a prompt sentence such as:
“The user's drowsiness state is ‘sleepy’. Please generate a three-minute pop music track with medium intensity, moderate tempo around 120 BPM, clear rhythm, and an uplifting mood that helps the user stay awake.”

When the drowsiness level is “very sleepy,” the server may generate a prompt sentence such as:
“The user's drowsiness state is ‘very sleepy’. Please generate a three-minute, high-energy electronic dance music track with maximum intensity, a fast tempo around 138 BPM, strong bass, pronounced percussion, and bright synth leads to quickly wake the user up.”

The server can generate other prompt sentences following the same structure. For example, when the drowsiness level is “a little sleepy,” the server may generate a prompt sentence such as:
“The user's drowsiness state is ‘a little sleepy’. Please generate a three-minute light pop track with low-to-medium intensity, a tempo around 110 BPM, gentle but clear rhythm, and a slightly uplifting mood that helps the user stay focused without causing stress.”

The server uses a generative AI model implemented on one or more hardware accelerators to generate music data from the prompt sentence. The generative AI model may be a neural network-based sequence generation model using an architecture such as a Transformer architecture. The server stores the generative AI model or a client library for accessing the generative AI model in the memory. The generative AI model may be trained to accept natural language input and output sequences of symbolic musical events or directly output audio samples.

In one embodiment, the generative AI model is implemented using a deep learning framework such as TensorFlow or a similar library. The generative AI model includes an encoder that converts tokenized words from the prompt sentence into vector embeddings, a stack of attention layers and feed-forward layers that perform context modeling, and a decoder that autoregressively outputs tokens representing musical events such as note-on events, note-off events, pitches, velocities, and timing offsets. The generative AI model is trained using a large corpus of musical sequences and associated descriptive texts. During training, the server provides text descriptions and target musical event sequences to the generative AI model, computes a loss function such as a cross-entropy loss between predicted tokens and target tokens, and updates the model weights using a gradient-based optimization method such as a stochastic gradient descent method or an adaptive moment estimation method. The server may apply regularization techniques and data augmentation techniques, for example tempo scaling or transposition of training sequences, in order to improve generalization. The server may store the learned weights in a hardware storage device and load the weights into accelerator memory at inference time.

In another embodiment, the generative AI model outputs an audio waveform instead of symbolic events. In that case, the generative AI model may include a separate decoder that uses a neural vocoder architecture, such as an autoregressive waveform model or a flow-based model, to map intermediate musical tokens or spectrogram representations to discrete-time audio samples. The server controls the sample rate, the bit depth, and the output length by providing appropriate parameters alongside the prompt sentence.

The server sends the prompt sentence and related control parameters to the generative AI model through an internal interface or an external API endpoint. The server uses the communication interface or an internal message bus to provide the input tokens, temperature parameters, maximum sequence length parameters, and other decoding parameters to the generative AI model. The generative AI model processes the prompt sentence and returns either symbolic music data or raw audio data. The server receives this output and stores the music data in the memory for further processing.

The server executes audio signal processing on the music data. When the generative AI model outputs symbolic music data such as a series of note events, the server uses a software synthesizer to convert the symbolic events into an audio waveform. For example, the server can use a sound synthesis engine that performs sample-based synthesis or subtractive synthesis, controlled by note-on and note-off events, velocity values, and control change messages. The server can apply envelope functions, filtering, and spatialization according to the attributes of the music generation conditions. When the generative AI model outputs an audio waveform directly, the server reads the waveform as a sequence of numerical values representing sound pressure levels in time.

The server performs duration adjustment by trimming or extending the waveform. The server measures the actual length of the waveform and compares it with the target duration specified in the music generation conditions. When the waveform exceeds the target duration, the server truncates samples at the end of the sequence. When the waveform is shorter than the target duration, the server may loop selected segments or apply time-stretching algorithms that preserve pitch characteristics while extending the temporal length. The server uses signal processing algorithms implemented in software libraries to perform these operations efficiently.

The server performs volume normalization by computing a measure of loudness, such as a root mean square value or a standardized loudness measure, and scaling the waveform so that the loudness falls within a predetermined target range. This operation ensures that the audio content presented to the user has stable and predictable loudness, reducing the need for the user to manually adjust volume and reducing the risk of clipping or distortion in the audio output apparatus.

The server converts the encoding format of the audio data to match the capabilities of the terminal. The server may encode the audio waveform into a compressed format such as a common audio compression format using an audio encoding library. The server may select the bit rate and codec parameters based on the network conditions and performance considerations. By compressing the audio data before transmission, the server reduces communication load, shortens transmission time, and improves energy efficiency on both the server and the terminal.

The server adds metadata to the processed music data. The server may embed fields such as title, genre, intended drowsiness level, generation time, and internal identifiers into the audio file header or into a separate metadata record that is stored alongside the audio file. The server stores the processed music data and associated metadata in the storage apparatus, such as a disk array or a network storage service.

The server generates response information that includes retrieval identification information for the processed music data. The retrieval identification information may be an opaque identifier, a path in the storage apparatus, or a resource locator that the terminal can use to fetch the audio content. The server transmits the response information to the terminal through the communication interface. By sending only identification information rather than the full audio data in some configurations, the server can further reduce network overhead and can reuse cached content when appropriate.

The terminal receives the response information, interprets the retrieval identification information, and retrieves the processed music data from the server or from the storage apparatus. The terminal decodes the audio data using an audio decoder implemented in hardware or software. The terminal feeds the decoded digital samples to a digital-to-analog conversion module and then to the audio output apparatus. The user hears the generated audio content through speakers or headphones. Because the server has normalized tempo, duration, and loudness, the terminal can perform playback without additional adjustment steps, which simplifies processing on the terminal side.

The terminal may also collect evaluation information from the user after playback. For example, the terminal may display a question such as “Did this music help you feel more awake?” and may allow the user to select a response such as “yes” or “no” or a numerical rating. The user inputs the evaluation information via the input apparatus. The terminal sends the evaluation information to the server together with the original state information or a session identifier.

The server stores the evaluation information as part of the history information in the database.

The server associates each evaluation record with the corresponding state information, music generation conditions, and processed music data identifiers. The server may maintain additional fields such as time-of-day, device type, and previous outcomes, so that the server can analyze how specific combinations of parameters perform in different contexts.

The server uses the history information to update the mapping between state information and music generation conditions. In one embodiment, the server maintains a set of numerical parameters that adjust the probability of selecting certain music types or intensities for each drowsiness level. The server updates these parameters using a learning algorithm that increments or decrements parameter values based on the evaluation information. For example, when a certain combination of tempo and intensity receives high effectiveness ratings for a given drowsiness level, the server increases a weight associated with that combination. When ratings are low, the server decreases the weight. Over time, the server thus refines the mapping so that the probability of generating effective music content for each drowsiness level increases.

In another embodiment, the server uses a supervised learning model to predict optimal music generation conditions from state information and context features. The server may implement a regression model, a decision tree model, or a small neural network. The server uses the history information, including drowsiness levels, selected music generation conditions, and evaluation scores, as training data. The server computes a loss function that measures the difference between predicted and observed evaluation scores and updates model parameters accordingly. By embedding this model into the mapping function, the server can directly compute music generation conditions from state information in a data-driven manner.

The server thereby implements a closed-loop control system. The server does not simply automate a human content selection task but instead provides a technical mechanism that continuously transforms coarse user state inputs into fine-grained control parameters for a generative AI model, optimizes prompt sentence content, and adapts audio processing and distribution. The server improves computational efficiency by selecting tempo, duration, and encoding parameters that minimize unnecessary computation and bandwidth. The server improves accuracy of targeting user drowsiness levels by adjusting mapping rules based on empirical feedback. The server also improves data management by structuring history information so that each element of state information, generation conditions, and evaluation information is linked and queryable.

The generative AI model contributes to this improvement by using an architecture and training procedure that are not equivalent to manual human composition. The generative AI model processes high-dimensional feature vectors, performs self-attention operations that scale with sequence length, and uses parameterized weights that can only be efficiently managed by a computing device. The server configures decoding parameters such as sampling temperature and top-k or nucleus sampling thresholds to balance creativity and stability of generated content. These parameters are tuned to maintain short inference time while ensuring that generated music remains consistent with tempo and intensity requirements. As a result, the system achieves a technical effect in which the time from user input to audio playback is reduced compared to systems that rely on ad hoc or manual prompt creation, and the probability that the audio content matches system-level constraints on loudness and length is increased.

In addition, the server may deploy multiple generative AI models optimized for different ranges of tempo or different types of sound content. The server can select an appropriate model variant based on the music generation conditions. For example, the server may select a model variant trained predominantly on rhythmic content when the intensity is high and a model variant trained on softer content when the intensity is low. This model selection mechanism reduces the number of tokens that need to be processed by any single model and reduces memory consumption and processing time on hardware accelerators.

In some embodiments, the server adjusts communication load by performing audio transcoding and caching operations. When a specific combination of drowsiness state and environment is frequently requested and yields high evaluation scores, the server may store commonly used processed music data in a cache memory with short access time. The server may respond to subsequent requests using cached content instead of triggering a new generative inference. This reduces load on the generative AI model and the accelerator hardware, decreases energy consumption, and improves response time for the user.

The terminal may incorporate further control logic to handle network interruptions, buffering, and volume safety limits. The terminal may monitor buffer fullness and automatically adjust prefetch behavior based on expected playback duration. The terminal may also synchronize user interface updates with audio playback so that the user receives consistent feedback.

These operations, combined with the server-side control of generation and post-processing, result in a coordinated system that optimally distributes computational tasks between the server and the terminal.

Alternative embodiments may include different generative AI architectures. For example, the server may use a recurrent neural network model with attention, rather than a Transformer, or may use a hybrid model that combines symbolic event generation with a separate waveform synthesis network. The server may also support different audio codecs or may use different loudness normalization standards. The core structure remains that the server converts user-provided drowsiness state information into structured music generation conditions, constructs a prompt sentence for a generative AI model, controls the generative AI model to generate music data, and then performs audio signal processing and adaptive control based on history information so that the computer system itself operates with improved speed, resource efficiency, and functional accuracy in generating and delivering sound content matched to the user's drowsiness level.

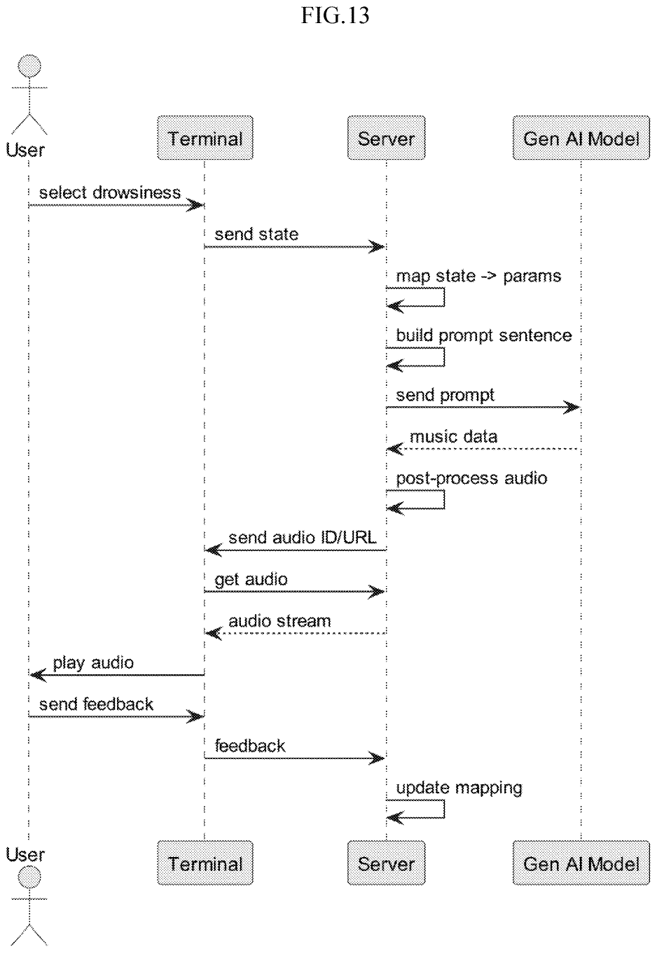

The following describes the processing flow using FIG. 13.

### Step 1

The terminal displays, on a display apparatus, a user interface that lists selectable drowsiness levels such as “a little sleepy,” “sleepy,” and “very sleepy.” The input of this step is no prior user state and the current screen context stored in the terminal memory. The output of this step is a rendered graphical screen with selectable elements associated with internal codes for drowsiness levels.

### Step 2

The user operates the input apparatus of the terminal, for example by tapping one of the displayed options, to select a current drowsiness level. The input of this step is the graphical user interface from Step 1 and the user's physical touch action. The terminal converts the touch coordinates into an event, determines which selectable element has been activated, and maps the selected element to structured state information including at least a drowsiness code and a timestamp. The output of this step is state information stored in the terminal memory, for example a record containing a user identifier and a drowsiness code such as “SLIGHT,” “MEDIUM,” or “HEAVY.”

### Step 3

The terminal constructs a request message including the state information and transmits the request to the server via a communication module. The input of this step is the structured state information created in Step 2. The terminal serializes this state information into a message body, attaches protocol headers, and encapsulates the message for transmission over a communication network. The output of this step is a network message that is sent to the server and received by the server through a communication interface.

### Step 4

The server receives the request message and extracts the state information. The input of this step is the network message produced in Step 3. The server parses the message headers and body, validates that required fields such as user identifier and drowsiness code are present, and stores the parsed data in an internal data structure in memory. The output of this step is validated state information represented as fields in a server-side record, including at least a user identifier, a drowsiness code, and a timestamp.

### Step 5

The server determines music generation conditions based on the validated state information. The input of this step is the drowsiness code from Step 4. The server applies a mapping function, such as a rule table or a learned function, that transforms the drowsiness code into music generation parameters including a type of sound content, an intensity level, a tempo value, and a target playback duration. The server may also compute auxiliary parameters such as rhythmic complexity and spectral brightness. The output of this step is a music generation condition record stored in memory, containing numerical and categorical fields that specify how the subsequent audio content should be generated.

### Step 6

The server generates a prompt sentence in natural language from the music generation conditions. The input of this step is the music generation condition record created in Step 5.

The server applies string formatting operations that take numerical tempo and duration values and convert them into descriptive phrases, and that combine these phrases with text indicating the user's drowsiness state and the desired type and intensity of sound. The server thus assembles a coherent text string that describes the required characteristics of the music. The output of this step is a prompt sentence stored as a text field in memory, for example a sentence such as “The user's drowsiness state is ‘very sleepy’. Please generate a three-minute, high-energy electronic dance music track with maximum intensity, a fast tempo around 138 BPM, strong bass, pronounced percussion, and bright synth leads to quickly wake the user up.”

### Step 7

The server invokes a generative AI model using the prompt sentence and receives music data from the model. The input of this step is the prompt sentence produced in Step 6 and control parameters such as maximum sequence length and sampling temperature. The server tokenizes the prompt sentence, sends the tokens and parameters to the generative AI model through an inference interface, and executes neural network inference that transforms the input tokens into an output sequence of music tokens or audio samples. The output of this step is music data representing the generated sound content, stored either as symbolic control data such as note events or as encoded audio data, in the server memory.

### Step 8

The server performs audio signal processing on the generated music data to produce processed music data. The input of this step is the raw music data from Step 7 and the music generation conditions from Step 5. The server computes the actual duration of the music data and, when necessary, trims or loops sections to match the target duration, adjusts amplitude samples to normalize loudness to a target level, converts the encoding format into a desired output codec and bitrate, and attaches or embeds metadata fields such as title and intended drowsiness level. The output of this step is processed music data in a distribution-ready audio format stored in the server memory.

### Step 9

The server stores the processed music data in a storage apparatus and generates retrieval identification information. The input of this step is the processed music data produced in Step 8. The server writes the processed music data to a file or object in the storage apparatus and assigns an identifier such as a path, key, or resource locator. The server records this identifier in an index or database entry together with the associated user identifier and state information. The output of this step is retrieval identification information that uniquely identifies the stored processed music data.

Step 10

The server creates and transmits response information including the retrieval identification information to the terminal. The input of this step is the retrieval identification information from Step 9. The server constructs a response message that contains the identification information and may include additional fields such as the determined type of sound content and intensity level, serializes the message, and transmits it to the terminal via the communication interface. The output of this step is a response message received by the terminal that enables the terminal to obtain the processed music data.

### Step 11

The terminal receives the response information and acquires the processed music data using the retrieval identification information. The input of this step is the response message from Step 10. The terminal parses the message, extracts the retrieval identification information, and issues a subsequent request to the server or storage apparatus to download or stream the corresponding processed music data. The output of this step is decoded audio samples or a buffered audio stream in the terminal memory ready for playback.

### Step 12

The terminal reproduces the processed music data via an audio output apparatus for the user. The input of this step is the audio stream or audio file obtained in Step 11. The terminal decodes the encoded audio, converts the digital samples to an analog signal using a digital-to-analog converter, and drives the loudspeaker or headphone interface while updating any graphical playback indicators on the display. The output of this step is an acoustic waveform perceived by the user as music and a playback completion status stored in the terminal.

### Step 13

The terminal collects evaluation information from the user regarding the effect of the processed music data and sends the evaluation information to the server. The input of this step is the playback completion status from Step 12 and a user interaction with an evaluation interface, such as pressing a button indicating whether the user feels more awake. The terminal converts the user's evaluation into a structured record that includes a rating or categorical label and associates it with the session identifier or retrieval identification information. The terminal transmits this evaluation record to the server via the communication module. The output of this step is an evaluation message received by the server.

### Step 14

The server updates history information and mapping logic based on the evaluation information. The input of this step is the evaluation message from Step 13 together with previously stored state information, music generation conditions, and identifiers for the processed music data. The server stores the evaluation information in a database as part of the history of that session and computes updated numerical parameters or rule weights that adjust how music generation conditions are selected for each drowsiness level. The server may, for example, increment a weight for a particular tempo and intensity combination when positive evaluations are received and decrement the weight when negative evaluations are received. The output of this step is an updated mapping between state information and music generation conditions stored in server memory, which will be used as input in subsequent executions of Step 5 to refine future prompt sentences and generated music data.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional wake-up or alerting systems that use audio playback typically rely on fixed playlists, simple volume changes, or coarse sensor thresholds. Such systems generally map a detected drowsiness level directly to a pre-stored sound or to a basic parameter change, without generating content that is tailored to a current fine-grained user state. As a result, these systems often fail to provide sufficient arousal for highly drowsy users, or conversely, they may produce overly strong or emotionally inappropriate audio for users who are only slightly drowsy or are in a particular emotional condition.

Additionally, conventional systems usually process sensor data and user input in isolation. For example, a system may classify drowsiness from camera images, but ignore explicit user self-reports, or may ignore emotional context such as stress, sadness, or frustration. This leads to an incomplete representation of user state, reducing the effectiveness of any adaptive control.

From a computing perspective, existing architectures commonly treat a generative AI model, if used at all, merely as a black-box music source invoked by a simple style keyword. They do not exploit structured state-dependent prompt generation, iterative feedback loops, or dynamic adjustment of generative parameters based on continuous sensor monitoring. Consequently, the computing system does not fully leverage the expressive control surface of the generative AI model, and the overall human-machine interaction remains static and inefficient.

Furthermore, traditional media playback pipelines in terminals or in-vehicle devices are not designed to close the loop between low-level sensor streams and high-level content creation. There is often no mechanism to: (i) integrate multimodal features such as facial landmarks, eye-closure measures, biological signals, and user-entered information into a unified, machine-interpretable profile; (ii) convert that profile into a structured acoustic parameter set; and (iii) automatically construct a semantically rich prompt sentence that precisely instructs a generative AI model to produce content optimized for the current context. This results in a technical bottleneck in the dataflow from sensing, through inference, to content generation.

In addition, typical systems do not provide a real-time control loop in which a processor continuously monitors the user while audio is playing, re-evaluates drowsiness and emotion, and adaptively regenerates or adjusts audio content by updating the prompt and re-invoking the generative AI model. Without such a loop, the system cannot dynamically converge toward a desired arousal state or maintain safety in a changing environment, such as during long-distance driving.

Accordingly, there is a need for a computer-implemented system that improves how a processor ingests multimodal sensor and user-entered data, generates a refined representation of user drowsiness and emotion, maps that representation into detailed acoustic parameters, automatically composes a state-aware prompt sentence, and interacts with a generative AI model within a closed control loop. Such a system should enhance the technical performance of the computing platform itself, for example, by improving the accuracy and granularity of state estimation, the expressiveness and relevance of generated prompts, and the responsiveness and stability of the adaptive audio-generation process.

The specific processing by the specific processing unit 290 of the data processing device 12 in Application Example 2 is realized by the following means.

The present invention provides a server comprising a processor configured to acquire biological information and operation information of a user from at least one input device including an image acquisition device, an audio acquisition device, and a biological signal acquisition device; to preprocess image information, audio information, and biological signal information acquired from the input device, and extract at least a face region, an eye region, audio features, and biological features; to numerically evaluate a drowsiness degree of the user and determine a discrete drowsiness state of the user by inputting the extracted features and drowsiness information input by the user through a terminal into a machine learning model; to input the face region and the audio information into an emotion estimation model and identify an emotion state of the user; to determine a type of acoustic content and intensity parameters on the basis of the drowsiness state and the emotion state by using a rule-based logic or a learned decision logic, and generate an acoustic parameter set including at least a genre, a volume, a tempo, and a playback duration; to automatically generate a prompt sentence for a generative AI model by combining the acoustic parameter set with natural-language text describing the drowsiness state and the emotion state; to transmit the prompt sentence to a generative AI model disposed inside or outside the system and obtain original acoustic data from the generative AI model; to perform signal processing including length adjustment and volume normalization on the obtained acoustic data so as to conform to playback conditions defined by the acoustic parameter set; and to continuously monitor the state of the user during playback of the acoustic data by repeatedly acquiring information from the input device, re-evaluate the drowsiness state and the emotion state, and, when necessary, update the acoustic parameter set and the prompt sentence and repeatedly request generation of acoustic data from the generative AI model. This enables the computing system to implement a closed feedback loop that tightly couples multimodal sensing, state estimation, structured prompt generation, and adaptive control of a generative AI model, thereby improving the technical functioning of the processor in generating context-appropriate audio content, enhancing responsiveness to changing user states, and increasing the effectiveness and safety of arousal support compared to conventional static playback or non-adaptive generative systems.

The term “processor” refers to a hardware computation unit, such as a central processing unit or a microcontroller, configured to execute instructions of one or more programs to perform the functions described herein.

The term “input device” refers to any hardware component configured to acquire data related to a user, including but not limited to an image acquisition device, an audio acquisition device, a biological signal acquisition device, and a user-operated terminal.

The term “image acquisition device” refers to a hardware component configured to capture image data of a user, such as a camera or an infrared imaging sensor.

The term “audio acquisition device” refers to a hardware component configured to capture sound data, such as a microphone or an array of microphones.

The term “biological signal acquisition device” refers to a hardware component configured to measure biological signals of a user, such as heart rate, pulse, skin conductance, or similar physiological parameters.

The term “operation information” refers to information indicating an operation performed by a user on a terminal or other interface, including explicit input of a drowsiness state, selection of options on a display, or activation of control buttons.

The term “image information” refers to digital data representing still images or video frames acquired from an image acquisition device.

The term “audio information” refers to digital data representing sound, including speech signals and environmental audio, acquired from an audio acquisition device.

The term “biological signal information” refers to digital data representing one or more biological signals of a user acquired from a biological signal acquisition device.

The term “preprocess” refers to performing one or more operations on raw data, such as conversion of format, normalization, filtering, resizing, or segmentation, in order to prepare the data for further analysis.

The term “face region” refers to a portion of an image or video frame that contains a representation of the user's face, extracted or identified by image processing.

The term “eye region” refers to a portion of a face region that contains at least one of the user's eyes, extracted or identified by image processing or landmark detection.

The term “audio features” refers to numerical values or patterns derived from audio information, such as energy, pitch, spectral coefficients, or prosody indicators, used for analysis by a model.

The term “biological features” refers to numerical values or patterns derived from biological signal information, such as averaged heart rate, heart rate variability, or similar physiological indices.

The term “drowsiness information” refers to information indicating a subjective or objective drowsiness state of a user, including self-reported labels such as “a bit sleepy,” “sleepy,” or “very sleepy,” or equivalent coded values.

The term “machine learning model” refers to a computational model trained using sample data to perform a task such as classification or regression, and includes but is not limited to neural networks, decision trees, or ensemble models.

The term “drowsiness degree” refers to a numerical value or score representing a level of sleepiness of a user, obtained by processing features and drowsiness information with the machine learning model.

The term “drowsiness state” refers to a discrete categorization of the user's sleepiness level, such as a set of stages or classes derived from the drowsiness degree.

The term “emotion estimation model” refers to a computational model or engine configured to receive at least facial and audio information and to output an estimated emotion state of a user.

The term “emotion state” refers to a classification of a user's emotional condition, such as “happy,” “sad,” “stressed,” “relaxed,” or other categories definable by the emotion estimation model.

The term “rule-based logic” refers to a decision mechanism that determines outputs based on predefined rules or conditions applied to inputs such as the drowsiness state and the emotion state.

The term “learned decision logic” refers to a decision mechanism derived from training data, such as a trained model that maps input states to output parameters without requiring manually defined rules.

The term “acoustic content” refers to audio material to be reproduced to a user, including music, sound effects, or other sound sequences generated or selected by the system.

The term “intensity parameters” refers to parameters defining the strength or energy of acoustic content, including at least volume and tempo and optionally rhythm complexity or spectral brightness.

The term “acoustic parameter set” refers to a group of parameters defining characteristics of acoustic content, including at least a genre, a volume, a tempo, and a playback duration, and optionally other parameters.

The term “genre” refers to a category or style of acoustic content, such as rock, metal, pop, classical, ambient, or similar stylistic classifications.

The term “volume” refers to an output level parameter specifying loudness of reproduced acoustic content as perceived by a user.

The term “tempo” refers to a temporal parameter of acoustic content, typically expressed as beats per minute, indicating the speed of the content.

The term “playback duration” refers to a target time length for the reproduction of acoustic content, such as a number of seconds or minutes.

The term “prompt sentence” refers to natural-language text generated by the processor to instruct a generative AI model to produce acoustic content satisfying specified conditions.

The term “generative AI model” refers to a computational model configured to generate content, such as audio, symbolic music data, or other outputs, based on an input prompt sentence or similar conditioning information.

The term “original acoustic data” refers to acoustic content generated by the generative AI model in response to the prompt sentence, which is not merely a retrieval of pre-stored audio.

The term “signal processing” refers to operations applied to acoustic data, including but not limited to length adjustment, volume normalization, filtering, or format conversion.

The term “length adjustment” refers to modifying acoustic data so that its time duration approximates or matches a target playback duration.

The term “volume normalization” refers to adjusting the amplitude of acoustic data to satisfy predetermined loudness criteria or to fit within a desired dynamic range.

The term “audio output interface” refers to a hardware or software component configured to output acoustic data to a reproduction device, such as an audio jack, a digital audio bus, or a wireless audio transmission interface.

The term “terminal” refers to an end-user device, such as a personal mobile device, a computing terminal, or a user interface unit, that communicates with the server and reproduces audio to the user.

The term “in-vehicle device” refers to a computing and audio reproduction unit installed in a vehicle, configured to communicate with the server and to output acoustic content to a driver or passenger.

The term “reproduction” refers to the process of converting acoustic data into audible sound through a loudspeaker or other audio transducer.

The term “loudspeaker” refers to a hardware component that converts electrical audio signals into sound waves perceivable by the user.

The term “start, stop, and volume of the reproduction” refers to control operations including initiating playback, terminating playback, and changing loudness during playback of acoustic content.

The term “situational description” refers to a portion of the prompt sentence that describes the context of use, including at least the user's drowsiness degree, the emotion state, and optionally an intended purpose such as promoting arousal.

The term “purpose of promoting arousal” refers to an intended effect of increasing alertness or wakefulness of the user by means of generated acoustic content.

In one embodiment, a server cooperates with at least one terminal and at least one sensor device to provide adaptive generation and playback of acoustic content tailored to a user's drowsiness state and emotion state. The server executes a plurality of software modules on a hardware platform including at least one processor, a memory, a non-volatile storage device, and a network interface. The terminal includes a display device, an audio output interface, a microphone, and optionally a camera, and is connected to the server through a communication network such as a wireless network or an in-vehicle communication network.

The server executes an acquisition module, a preprocessing module, a drowsiness estimation module, an emotion estimation module, a parameter decision module, a prompt generation module, a generative AI interface module, a signal processing module, and a playback control module. The modules are implemented in a programming language such as a general-purpose scripting language and use libraries such as a numerical computation library, an image processing library, an audio processing library, and a data-frame library.

The server acquires image information, audio information, and biological signal information from one or more input devices. The server uses, as the image acquisition device, for example, an RGB camera or an infrared camera mounted in a vehicle or integrated into a terminal. The server uses, as the audio acquisition device, a microphone connected to the terminal or to an in-vehicle device. The server uses, as the biological signal acquisition device, an optical pulse sensor, a heart rate sensor, or an equivalent physiological sensor interfaced via an in-vehicle bus. The server further acquires operation information from the terminal, including explicit selection of a drowsiness label by the user.

The server executes the preprocessing module to convert raw sensor data into analysis-ready data structures. The server uses an image processing library such as OpenCV to convert raw image frames into normalized image tensors, to perform face detection, and to crop a face region and an eye region. The server uses a facial landmark detection model, such as a regression-based landmark estimator, to obtain coordinates of facial keypoints around the eyes and mouth. The server computes eye aspect ratio values, eye-closure durations, blink rates, and head pose angles as numerical features. The server uses a numerical computation library such as NumPy to store these features in arrays.

The server executes a biological signal preprocessing pipeline using a scientific computation library. The server applies band-pass filters and smoothing filters to heart rate signals and computes time-domain metrics such as average heart rate and heart rate variability over sliding windows. The server converts the processed physiological features into normalized scalar values. The server then stores image-derived features, audio-derived features, and physiological features in a tabular structure using a data-frame library such as a data analysis library, together with operation information received from the terminal.

The terminal provides a user interface allowing the user to select a subjective drowsiness level from discrete options such as “a bit sleepy,” “sleepy,” and “very sleepy,” and to optionally provide a free-form description. The terminal transmits the selected label and any additional operation information to the server using a structured message over a network protocol. The server receives this information and converts the textual drowsiness label into a numerical code, such as 1, 2, or 3, and merges the numerical code with the sensor-derived features.

The server executes the drowsiness estimation module to compute a drowsiness degree. In one embodiment, the server uses a machine learning model implemented as a multi-layer neural network. The neural network includes an input layer whose dimension corresponds to the concatenated vector of image features, audio features, physiological features, and user-reported drowsiness code. The neural network further includes one or more hidden layers such as fully connected layers with rectified linear unit activation functions and an output layer that produces a probability distribution over discrete drowsiness classes. The server determines a drowsiness state by selecting the class with the highest probability and additionally outputs a continuous drowsiness score by computing a weighted sum of class indices and probabilities.

The server trains the neural network prior to deployment using a training dataset including synchronized sensor data and ground-truth drowsiness labels obtained from controlled experiments or from annotated logs. The server uses a loss function such as cross-entropy loss for the classification component and mean squared error for the regression component, and combines these losses with a weighting factor. The server optimizes network parameters using a gradient-based optimization algorithm such as stochastic gradient descent with momentum or an adaptive learning-rate optimizer. The server performs data augmentation at training time by applying random noise to sensor features and random temporal cropping of sequences, thereby increasing robustness and reducing overfitting. Because the network is optimized for this sensor configuration and feature set, the inference executed by the server at runtime achieves high accuracy at low latency, improving the technical performance of the system compared to naive threshold-based drowsiness detection.

The server executes the emotion estimation module to determine an emotion state of the user.

In one embodiment, the server uses a convolutional neural network for facial emotion recognition and a recurrent neural network or transformer-based model for vocal emotion recognition. The server inputs the cropped face region into the convolutional network to obtain emotion probabilities such as “happy,” “sad,” “stressed,” or “neutral.” The server inputs audio features such as mel-frequency cepstral coefficients into the recurrent or transformer model to obtain complementary emotion probabilities. The server fuses the visual and audio emotion estimates using a late-fusion rule, such as weighted averaging of probabilities, to obtain a final emotion state and confidence value. The server stores the emotion state along with the drowsiness state in memory as a compact state profile.

The server executes the parameter decision module to determine an acoustic parameter set. The server uses a combination of rule-based logic and optionally a secondary neural network. For example, the server maps a drowsiness state of “very sleepy” to a high-energy genre such as “aggressive metal” or “energetic rock,” sets a target tempo in a high beats-per-minute range, and sets a volume level close to an upper safety threshold. The server adjusts parameters based on the emotion state; for a user classified as “sad” and “a bit sleepy,” the server may select a more uplifting but less harsh genre and moderate intensity. The server expresses the acoustic parameter set as a structured record including at least fields for genre, volume level, tempo, rhythm complexity, spectral brightness, and playback duration. The server stores this record in the data-frame structure, associating it with the corresponding state profile.

The server executes the prompt generation module to construct a prompt sentence for a generative AI model. The server uses a template-based text generation approach in which predefined patterns are filled with values taken from the acoustic parameter set and from the state profile. The server combines, in natural language, the genre, tempo, volume, and duration parameters with a situational description of the user's drowsiness and emotion. For example, the server generates a prompt sentence such as:
“Generate a 3-minute track of very aggressive metal music with maximum intensity, fast tempo, and powerful drums to wake up a driver whose drowsiness state is ‘very sleepy’.”

In another example, the server generates a prompt sentence such as:
“Create an original up-tempo pop song of about 3 minutes with medium intensity and a bright, uplifting mood to help a user who feels sleepy to wake up and regain focus at work.”

In yet another example, the server generates a prompt sentence such as:
“Generate a 3-minute uplifting rock track with moderately high intensity and optimistic mood to gently wake up a user who is a bit sleepy and feels sad, without causing additional stress.”

The server generates these prompt sentences such that they explicitly encode technical parameters (duration, tempo, intensity) as well as contextual constraints (current drowsiness degree and emotion state). This structured prompt design improves the controllability and repeatability of the generative AI model compared to a simple style keyword, thus improving the technical functioning of the content generation process.

The server executes the generative AI interface module to communicate with a generative AI model. In one embodiment, the generative AI model resides on a remote computing system and exposes an application programming interface. The server transmits the prompt sentence, together with generation parameters such as sampling temperature, maximum sequence length, and desired output format (for example, symbolic music data or audio waveform), to the generative AI model. The generative AI model is configured as a sequence-generation network, such as a transformer-based architecture with attention mechanisms, trained on a large corpus of music representation data and corresponding textual descriptions.

The generative AI model receives the prompt sentence and produces original acoustic data. When the output is symbolic, such as a sequence of notes in a standard music representation, the server converts the symbols into an audio waveform using a synthesizer component. When the output is a waveform directly, the server decodes the data into an audio buffer stored in memory. The server's use of a structured, state-aware prompt enables the generative AI model to converge faster to content that satisfies the required constraints, thereby reducing the number of generation iterations and network calls and improving computational efficiency and communication efficiency.

The server executes the signal processing module to adapt the generated acoustic data to the playback conditions defined by the acoustic parameter set. The server uses an audio processing library to perform operations such as resampling, trimming or padding to match a target playback duration, and dynamic range compression to achieve volume normalization. The server ensures that the resulting waveform does not exceed a predefined safety threshold for sound pressure level. The server thereby guarantees consistent loudness and duration across different generation cycles, simplifying downstream playback control and improving user safety.

The server stores the processed acoustic data in a storage device or transmits it directly to the terminal or in-vehicle device. The terminal receives the acoustic data, buffers it in memory, and forwards it to an audio output interface connected to a loudspeaker. The terminal may use a media playback component such as a system media framework or a media player application to reproduce the audio content. The terminal may present playback controls to the user and may also provide visual indicators that the content is specifically generated based on their current state.

During playback, the server executes the playback control module in conjunction with the acquisition and estimation modules. The server continues to receive sensor data and operation information and to update the drowsiness and emotion estimates. When the server determines that the drowsiness degree remains above a defined threshold, the server increases intensity parameters or extends the playback duration in the next acoustic parameter set. When the server determines that the user has reached a safe and alert state, the server reduces intensity or terminates further generation requests. The server thus implements a closed feedback loop where the output of each generation cycle influences the input to the next generation cycle. This loop, implemented as an explicit state machine and parameter update logic, is not a mere automated version of human selection, but rather a machine-specific control strategy that continuously optimizes content based on quantitative feedback.

The server thereby improves computer technology in several ways. The server uses dedicated data structures, including unified feature vectors and parameter records, to tightly couple multimodal sensor processing with generative content control, which reduces redundant computations and improves memory locality. The server embeds decision-making into both the pre-generation and post-generation stages, which reduces the number of unsuccessful generations and network transactions, thereby lowering communication overhead. The server's neural network models perform inference using optimized architectures and loss functions, providing higher accuracy and faster evaluation than simplistic rule-based thresholds, which enhances the reliability of downstream safety functions, especially in driving scenarios. The server's structured prompt generation enables the generative AI model to operate under more precise constraints, reducing variance in generation outputs and decreasing the need for manual curation.

In one alternative embodiment, the server uses not only rule-based logic but also a reinforcement-learning agent that adjusts acoustic parameters over time. The reinforcement-learning agent receives, as a reward signal, a decrease in drowsiness degree across successive evaluations and penalizes configurations that fail to reduce drowsiness. The server updates the agent's policy using an off-policy value-based method or a policy-gradient method. This configuration allows the server to automatically explore parameter combinations that humans may not intuitively choose and to converge to parameter regimes that optimize arousal effect and resource usage over time.

In another embodiment, the server integrates additional sensors, such as a steering-wheel torque sensor or a lane-keeping deviation sensor in a vehicle, into the drowsiness estimation and acoustic parameter decision modules. The server thereby extends the feature space and improves predictive power without requiring additional user input. In still another embodiment, the server operates in a non-vehicular environment such as an office or a study room, where the terminal is a personal computer or mobile device, and the same dataflow and control logic are applied to prevent loss of focus during work or study.

In each embodiment, the server, the terminal, and the user cooperate in a defined technical workflow. The server processes sensor and operation data using specific neural architectures and rule-based logics; the server constructs explicit acoustic parameter sets; the server generates prompt sentences that fully specify technical and contextual constraints for the generative AI model; the server performs audio signal processing to meet safety and consistency requirements; and the server controls playback in a closed feedback loop based on re-evaluated drowsiness and emotion states. Because of this combination of technical measures, the system produces a measurable improvement in content relevance, reaction speed, safety performance, and computational efficiency, as compared to conventional systems that either use static audio playlists or invoke generative models with generic, non-structured prompts.

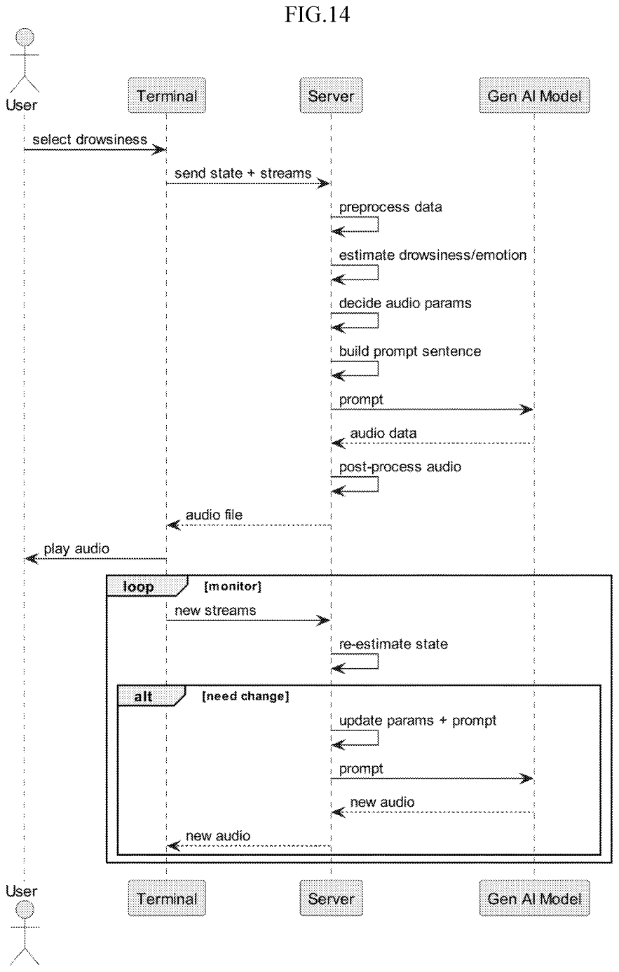

The following describes the processing flow using FIG. 14.

### Step 1

The user provides initial state information.

The user operates the terminal and selects a subjective drowsiness level such as “a bit sleepy,” “sleepy,” or “very sleepy” on a graphical user interface, and optionally speaks into a microphone or looks at a camera.

Input: The user's tap or click on a UI element and, optionally, raw voice and image signals captured at the terminal.

Output: A structured user input record at the terminal, for example, a label representing the selected drowsiness state and flags indicating availability of voice and image streams.

### Step 2

The terminal transmits user input and sensor streams to the server.

The terminal packages the selected drowsiness label and any additional metadata into a structured network message, and, when configured, starts streaming audio from the microphone and images or video frames from the camera to the server over a communication protocol.

Input: The user input record and raw audio/image streams captured at the terminal.

Output: A network request containing the drowsiness label and a continuous data stream of audio and image frames addressed to the server.

### Step 3

The server collects and buffers multimodal data.

The server receives the user-reported drowsiness label from the terminal and simultaneously receives image information from at least one image acquisition device, audio information from at least one audio acquisition device, and biological signal information from at least one biological signal acquisition device.

Input: Network packets containing the drowsiness label, image frames, audio samples, and biological signal samples.

Output: Synchronized data buffers stored in memory, each buffer containing time-stamped image, audio, biological signal, and drowsiness label entries for a defined observation window.

### Step 4

The server preprocesses image and audio information.

The server converts raw image frames into normalized arrays (for example, resizing and scaling pixel values), detects a face region using an image processing algorithm, and crops an eye region for each frame. The server also converts audio samples into a consistent sampling rate and extracts short-time analysis frames.

Input: Buffered raw image frames and raw audio samples.

Output: Preprocessed image tensors containing face and eye regions, and preprocessed audio frames suitable for feature extraction.

### Step 5

The server preprocesses biological signals and operation information.

The server filters raw biological signal samples using numerical filters to remove noise, computes time-domain and optionally frequency-domain metrics (such as average heart rate and variability), and associates these metrics with the same time window as the preprocessed image and audio data. The server also maps the user-reported drowsiness label into a numerical code.

Input: Raw biological signal samples and drowsiness label data from the terminal.

Output: Normalized biological feature vectors and a numerical drowsiness code aligned with the image and audio data in time.

### Step 6

The server constructs a unified feature vector.

The server concatenates eye-related features (such as eye aspect ratio and blink rate), facial posture features, audio features (such as mel-frequency coefficients or energy), biological features, and the numerical drowsiness code into a single multidimensional feature vector for the current observation window.

Input: Preprocessed face and eye regions, processed audio frames, biological feature vectors, and the drowsiness code.

Output: A unified feature vector stored in a data structure representing the multimodal state of the user.

### Step 7

The server estimates a drowsiness degree and state.

The server inputs the unified feature vector into a trained machine learning model, such as a multi-layer neural network implemented in software, and computes a numerical drowsiness degree and a discrete drowsiness state (for example, “a bit sleepy,” “sleepy,” or “very sleepy”). The server uses the model's output probabilities and a mapping rule to produce these values.

Input: The unified feature vector for the observation window.

Output: A drowsiness degree (continuous score) and a drowsiness state (discrete label) associated with the user at the current time.

### Step 8

The server estimates an emotion state.

The server feeds the cropped face region into a visual emotion classifier and the processed audio frames into a vocal emotion classifier, each implemented as a trained neural network, and then combines their outputs to determine an emotion state such as “sad,” “stressed,” “neutral,” or “happy.” The server applies a fusion rule, such as weighted averaging of probabilities, to decide a single emotion label and confidence.

Input: Preprocessed face/eye image data and audio feature data.

Output: An emotion state label and an associated confidence score.

### Step 9

The server builds a state profile.

The server aggregates the drowsiness degree, the drowsiness state, the emotion state, and their confidence values into a structured state profile object stored in memory. This profile represents the current estimated mental and physiological condition of the user.

Input: The drowsiness degree and drowsiness state from Step 7, and the emotion state from Step 8.

Output: A state profile object containing fields for drowsiness and emotion information.

### Step 10

The server decides acoustic parameters.

The server applies rule-based logic or learned decision logic to the state profile and selects a genre (for example, aggressive metal, energetic rock, up-tempo pop, or uplifting rock), sets intensity parameters (volume, tempo, rhythm strength, brightness), and determines a playback duration suitable for the current drowsiness and emotion. The server uses conditional rules such as increasing intensity for “very sleepy” users and moderating intensity for users with “sad” or “stressed” emotions.

Input: The state profile object.

Output: An acoustic parameter set including at least genre, target volume level, target tempo, intensity descriptor, and playback duration.

### Step 11

The server constructs a prompt sentence for a generative AI model.

The server inserts values from the acoustic parameter set and the state profile into a natural-language template to create a detailed prompt sentence that describes the desired acoustic content and the user's situation. The server ensures that the prompt includes explicit instructions on genre, intensity, tempo, duration, and the goal of waking or supporting the user.

Input: The acoustic parameter set and the state profile.

Output: A prompt sentence in natural-language text format ready to be transmitted to a generative AI model.

### Step 12

The server requests acoustic content from a generative AI model.

The server sends the prompt sentence to a generative AI model through an application programming interface, along with generation parameters such as temperature and maximum output length. The generative AI model processes the prompt and returns original acoustic data, either as symbolic music data or as an audio waveform, to the server.

Input: The prompt sentence and generation control parameters.

Output: Raw generated acoustic data produced in response to the prompt sentence.

### Step 13

The server post-processes the generated acoustic data.

The server converts the generated acoustic data into a standard audio format, adjusts the length of the audio signal to match the specified playback duration, and normalizes the volume to remain within safe and comfortable limits. The server may also apply equalization or dynamic range compression according to the intensity parameters in the acoustic parameter set.

Input: Raw generated acoustic data and the acoustic parameter set.

Output: A processed audio file or audio buffer conforming to the requested duration, volume, and intensity characteristics.

### Step 14

The server transmits the processed acoustic data to the terminal or in-vehicle device.

The server sends the processed audio content through a network connection to the terminal or directly to an in-vehicle audio system, indicating playback metadata such as recommended volume and duration.

Input: The processed audio file or buffer and associated playback metadata.

Output: A transmitted audio content stream or file received by the terminal or in-vehicle device.

### Step 15

The terminal reproduces the acoustic content to the user.

The terminal receives the audio content, loads it into a media playback subsystem, and outputs the sound through a loudspeaker or headphones connected to an audio output interface. The terminal may display playback controls and may automatically set initial volume based on the metadata from the server.

Input: The processed audio content and playback metadata from the server.

Output: Audible sound perceived by the user and a local playback status (such as playing, paused, or stopped).

### Step 16

The server monitors the user state during playback and decides on adaptation.

The server continues to receive and buffer new image, audio, and biological signal data, and repeats the drowsiness and emotion estimation steps while the current audio is playing. The server compares the updated drowsiness degree and state with previous values to determine whether the user's drowsiness has decreased sufficiently.

Input: New sensor data streams and the prior state profile.

Output: An updated state profile and a decision whether to increase, maintain, or decrease acoustic intensity or to stop generating further content.

### Step 17

The server updates parameters and prompts if further action is needed.

If the server determines that the user is still too drowsy or that the emotional state calls for a change, the server modifies the acoustic parameter set (for example, by raising intensity, changing genre, or extending playback duration) and generates a new prompt sentence reflecting these updated parameters. The server then repeats the content request, post-processing, and transmission steps.

Input: The updated state profile and the previous acoustic parameter set.

Output: A revised acoustic parameter set, a new prompt sentence, and subsequent new generated acoustic content for continued adaptive playback.

The data generation model 58 is a so-called generative artificial intelligence (AI). Examples of the data generation model 58 include generative AIs such as ChatGPT® (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

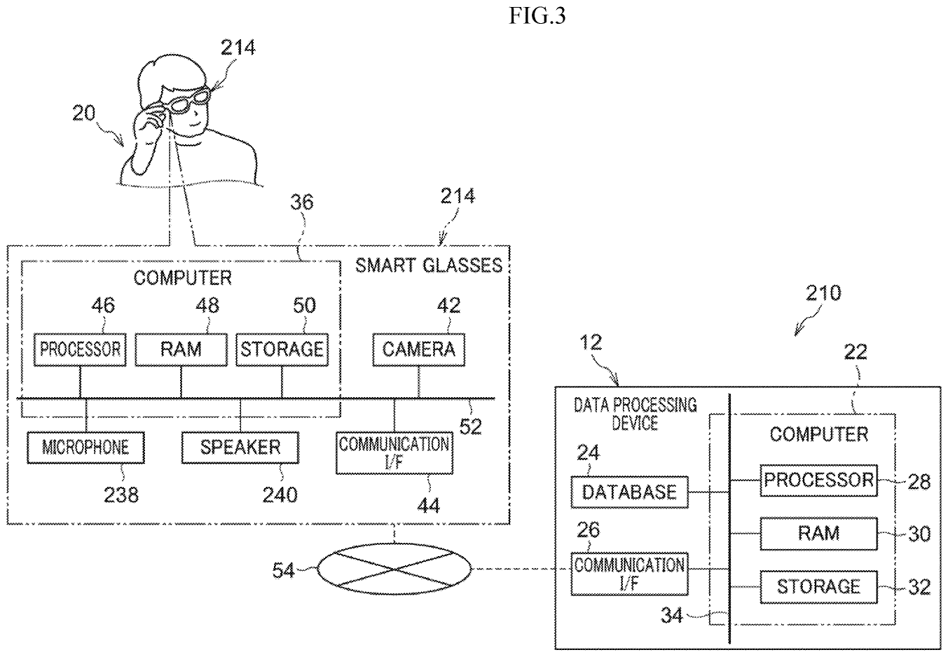

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

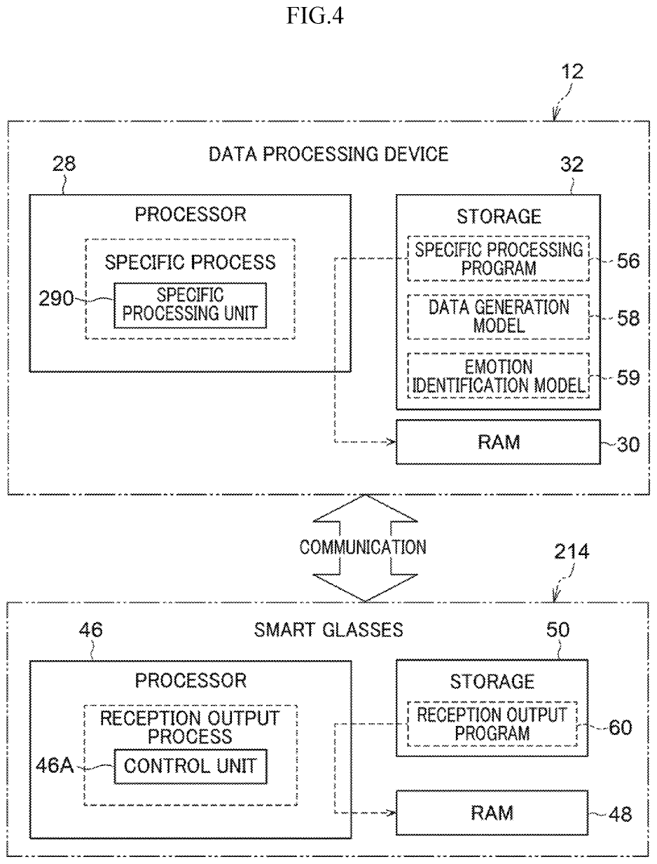

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT® (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

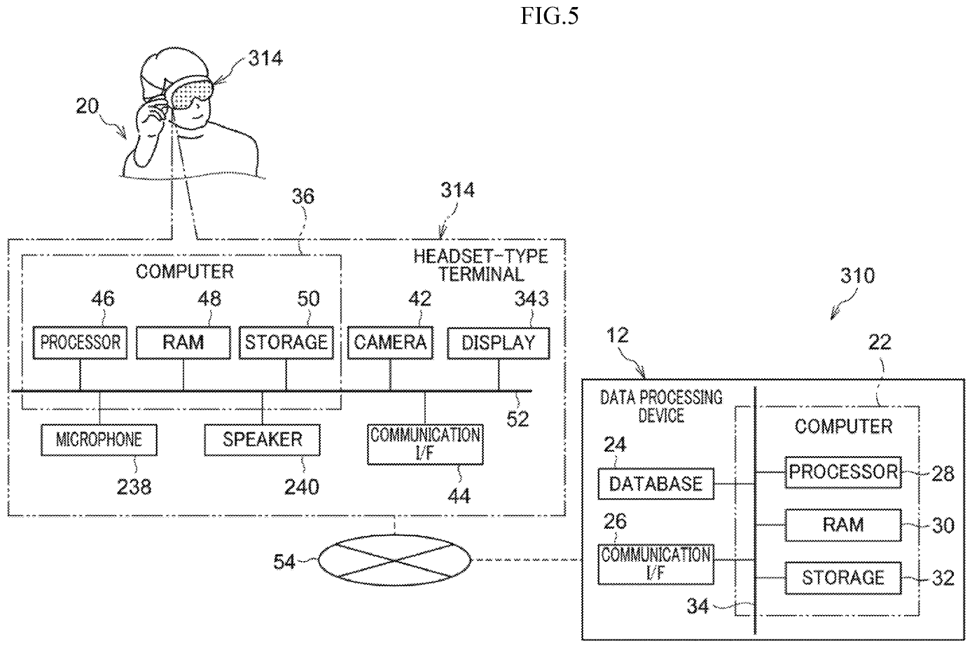

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

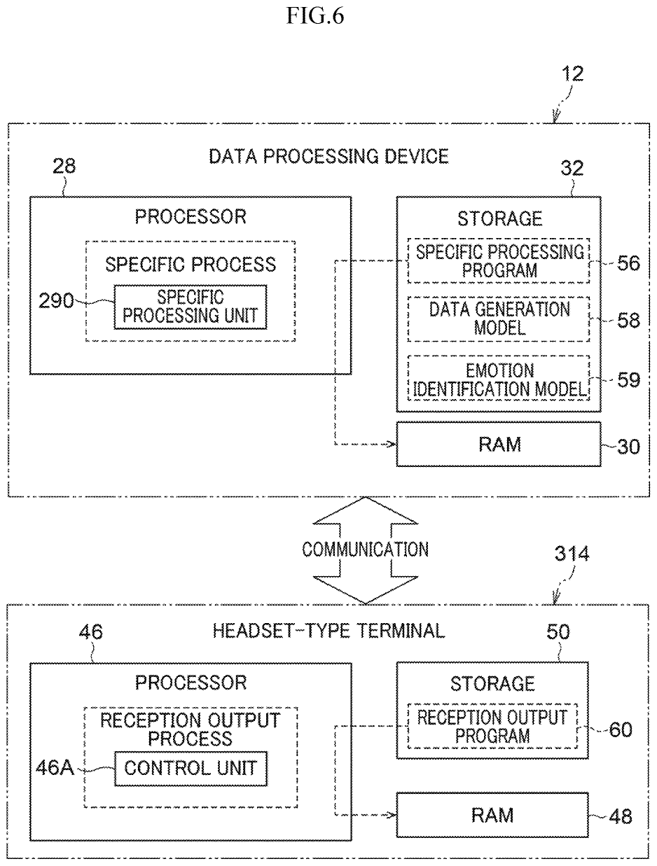

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT® (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

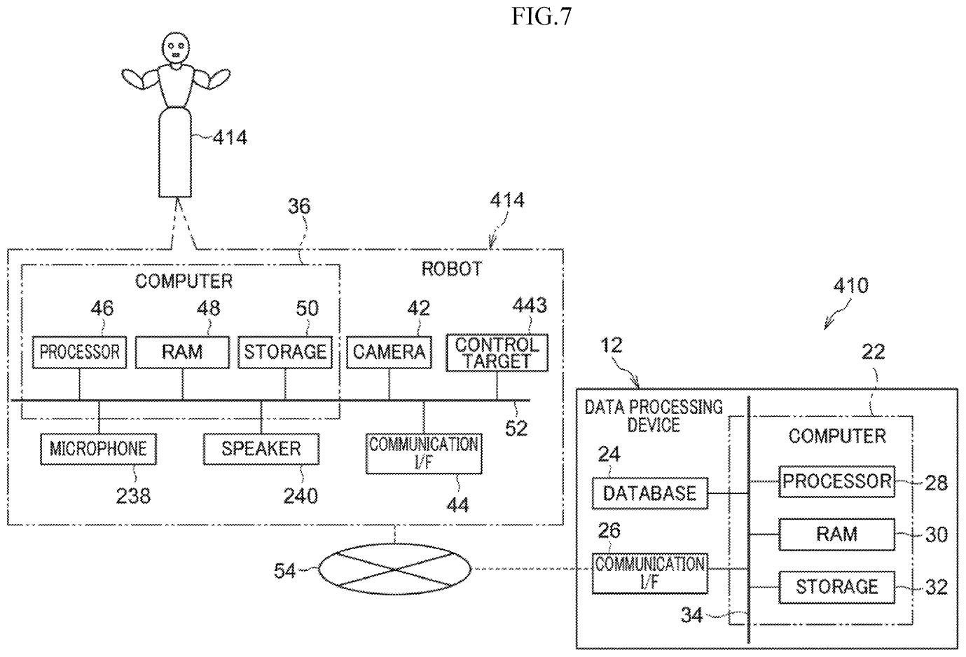

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

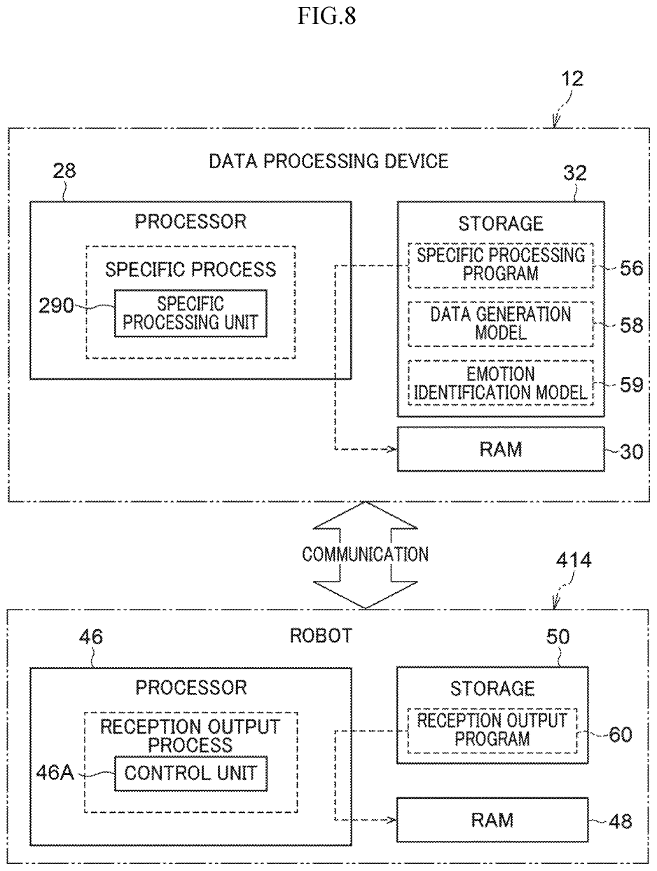

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT® (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

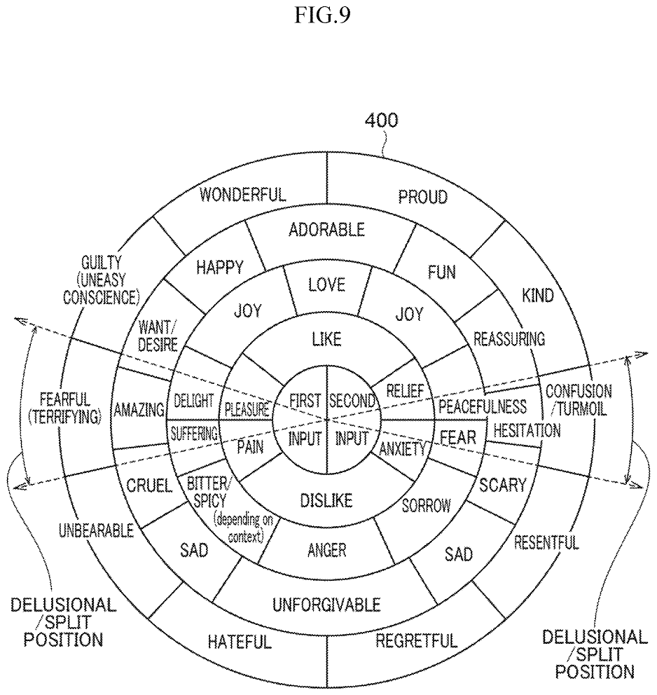

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

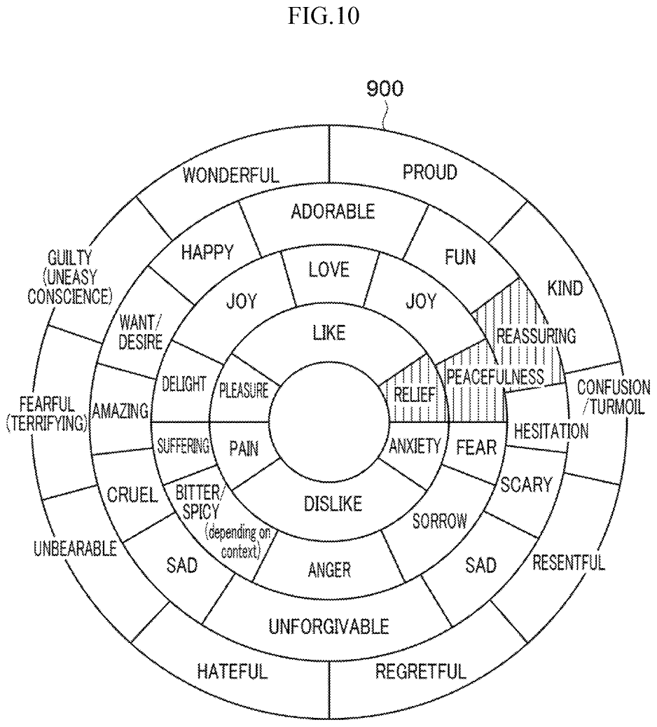

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor and a terminal,
wherein the processor is configured to
acquire state information related to an arousal state of a user via an information input unit or a detection unit of the terminal, and analyze the state information to convert the state information into evaluation information indicating a degree of the arousal state, and
determine, on the basis of the evaluation information, attribute information of acoustic content to be included in a prompt sentence to be input to a generative information processing model, the attribute information including at least a type of the acoustic content and a stimulation level of the acoustic content, and construct the prompt sentence including the attribute information and the evaluation information, and
input the prompt sentence to the generative information processing model, and cause the generative information processing model to generate structured data for the acoustic content in accordance with the prompt sentence, and
convert the structured data for the acoustic content into digital audio data by using software synthesis means and audio signal conversion means, compress the digital audio data according to a predetermined encoding scheme, store the compressed digital audio data in a storage unit, and output the compressed digital audio data in a format transmittable to the terminal, and
cause the terminal to obtain the compressed digital audio data, and, by using a playback control unit in the terminal, control an output level and a playback time of the compressed digital audio data, and present the acoustic content to the user via an acoustic output unit so as to improve the degree of the arousal state, and
acquire, via the terminal, evaluation information from the user regarding the generated acoustic content, store the evaluation information in association with the evaluation information indicating the degree of the arousal state and the attribute information of the acoustic content, and update a configuration of the prompt sentence and a decision logic for the attribute information of the acoustic content on the basis of a result of the storing.

### Supplementary 2

The system according to supplementary 1,
wherein the processor is configured to
use, as the generative information processing model, a trained model for generating time-series signal data, and cause the trained model to generate the structured data for the acoustic content as a time-series event sequence or a time-series signal sequence in accordance with the attribute information in the prompt sentence indicating the type of the acoustic content and the stimulation level.

### Supplementary 3

The system according to supplementary 1,
wherein the processor is configured to
cause the terminal, during playback of the digital audio data, to acquire operation information or biological information of the user and transmit the operation information or the biological information to the processor, and, on the basis of the operation information or the biological information, sequentially change at least one of the stimulation level or the type of the acoustic content included in the prompt sentence, operate the generative information processing model again to generate new acoustic content, and cause the terminal to perform continuous or switched playback of the new acoustic content so as to adjust the arousal state of the user in real time.

### Application Example 1

### Supplementary 1

A system comprising a processor,
wherein the processor is configured to
detect a face region and an eye region of a user from time-series data acquired from a detection apparatus that acquires physiological information or behavioral information of the user, by performing image processing on the time-series data, calculate feature values based on a posture of the face of the user and an opening and closing state of eyes of the user, and
classify a drowsiness state of the user as a stage-wise drowsiness level based on the feature values,
store correspondence information between the drowsiness level and music attribute information including a type of music, a tempo, a sound volume, and an energy amount associated with each drowsiness level, and determine a genre of music and an intensity of the music from the music attribute information according to the drowsiness level,
generate, in a natural language, a prompt sentence including the determined genre of music and intensity of the music, and further including a playback time, a tempo range, sound quality conditions, and conditions relating to a playback environment, and input the prompt sentence and acoustic parameters into a generative information processing model to cause the generative information processing model to generate original music data,
convert the music data generated by the generative information processing model into a predetermined audio format, perform signal processing including loudness normalization and adjustment of a playback start position on the music data, and generate playback audio data that is processable for output, and
re-evaluate the drowsiness level at predetermined time intervals, dynamically update the music attribute information and the prompt sentence according to a change in the drowsiness level, and control switching of the music data by re-executing a music generation process by the generative information processing model.

### Supplementary 2

The system according to supplementary 1,
wherein the processor is configured to
sequentially transmit the generated playback audio data to an acoustic output system including an acoustic output apparatus mounted in a vehicle, and control a playback sound volume and a playback timing according to the drowsiness level and the intensity of the music while continuously reproducing the playback audio data to the user.

### Supplementary 3

The system according to supplementary 1,
wherein the processor is configured to
store, as user attribute information, allowable types of music, an allowable tempo range, and an upper limit of sound volume based on operation input or preference information from the user, and correct the music attribute information and the prompt sentence in consideration of the user attribute information so as to adaptively change a music generation result by the generative information processing model for each user.

### Example 2

### Supplementary 1

A system comprising a processor,
wherein the processor is configured to
receive state information indicating a level of drowsiness of a user, the state information being selected by the user via an input apparatus and transmitted to the system via a communication network,
determine music generation conditions including at least a type of sound content, an intensity of the sound content, a tempo of the sound content, and a playback duration of the sound content, based on the received state information,
convert the determined music generation conditions into a prompt sentence configured as text information including natural language, and generate the prompt sentence for input to a generative AI model,
input the generated prompt sentence to the generative AI model that generates audio data, and acquire, from the generative AI model, music data representing the sound content as encoded data or control data,
perform audio signal processing on the acquired music data, the audio signal processing including at least one of a duration adjustment process, a volume normalization process, an encoding format conversion process, and a metadata addition process, to generate processed music data,
store the processed music data in a storage apparatus, and transmit response information including retrieval identification information for the processed music data to the input apparatus, and
store, as history information, the state information, the music generation conditions, and response information from the user with respect to the music data, and update a correspondence relationship between the state information and the music generation conditions based on the history information so as to adaptively change contents of a subsequently generated prompt sentence.

### Supplementary 2

The system according to supplementary 1,
wherein the processor is configured to
control the input apparatus so that the input apparatus acquires the processed music data on the basis of the retrieval identification information included in the response information,
decodes the processed music data, and reproduces the processed music data via an audio output apparatus.

### Supplementary 3

The system according to supplementary 1,
wherein the processor is configured to
control the input apparatus so that, after reproduction of the processed music data, the input apparatus acquires evaluation information regarding an effect of reducing the drowsiness of the user by the processed music data, and
store the evaluation information in association with the state information and the music generation conditions as part of the history information, and update, based on the evaluation information, at least one of a rule or a numerical parameter used for determining the type of sound content and the intensity of the sound content.

### Application Example 2

### Supplementary 1

A system comprising a processor,
wherein the processor is configured to
acquire biological information and operation information of a user from at least one input device including an image acquisition device, an audio acquisition device, and a biological signal acquisition device,
preprocess image information, audio information, and biological signal information acquired from the input device, and extract at least a face region, an eye region, audio features, and biological features,
numerically evaluate a drowsiness degree of the user and determine a discrete drowsiness state of the user by inputting the extracted features and drowsiness information input by the user through a terminal into a machine learning model,
input the face region and the audio information into an emotion estimation model and identify an emotion state of the user,
determine a type of acoustic content and intensity parameters on the basis of the drowsiness state and the emotion state by using a rule-based logic or a learned decision logic, and
generate an acoustic parameter set including at least a genre, a volume, a tempo, and a playback duration,
automatically generate a prompt sentence for a generative AI model by combining the acoustic parameter set with natural-language text describing the drowsiness state and the emotion state,
transmit the prompt sentence to a generative AI model disposed inside or outside the system and obtain original acoustic data from the generative AI model,
perform signal processing including length adjustment and volume normalization on the obtained acoustic data so as to conform to playback conditions defined by the acoustic parameter set, and
continuously monitor the state of the user during playback of the acoustic data by repeatedly acquiring information from the input device, re-evaluate the drowsiness state and the emotion state, and, when necessary, update the acoustic parameter set and the prompt sentence and repeatedly request generation of acoustic data from the generative AI model.

### Supplementary 2

The system according to supplementary 1,
wherein the processor is configured to
transmit the acoustic data to an audio output interface of a terminal or an in-vehicle device, reproduce the acoustic data to the user through a loudspeaker, and automatically control a start, a stop, and a volume of the reproduction in accordance with the drowsiness state and the emotion state of the user.

### Supplementary 3

The system according to supplementary 1,
wherein the processor is configured to
include, in the prompt sentence, explicit descriptions of the genre, the intensity, the tempo, and the playback duration included in the acoustic parameter set, and a situational description including the drowsiness degree and the emotion state of the user, thereby specifying to the generative AI model a purpose of promoting arousal of the user.

What is claimed is:

1. A system comprising:
circuitry configured to:
receive, via a communication interface coupled to a packet-switched network, state information from a terminal device, the state information being generated by at least one sensor or detection unit of the terminal device and representing an arousal state of a user, and analyze the state information to convert it into evaluation information indicating a degree of the arousal state;
determine, based on the evaluation information, a genre and an intensity of audio content, generate a prompt sentence for a generative AI model based on the determined genre and intensity, and input the prompt sentence to the generative AI model to instruct generation of the audio content; and
transmit audio data generated based on the generated audio content to the terminal device via the communication interface.

2. The system according to claim 1, wherein the circuitry is configured to quantify a degree of a drowsiness state of the user from the state information by converting sensor data into a numerical arousal score, and use the arousal score to determine the genre and the intensity of the audio content.

3. The system according to claim 2, wherein the circuitry is configured to classify the arousal score into a plurality of levels, and select an audio genre and an intensity corresponding to the classified level using a lookup table or classification model stored in a storage device.

4. The system according to claim 1, wherein the circuitry is configured to analyze a tone of voice of the user and a facial expression of the user based on audio data and image data received from the terminal device via the communication interface, and recognize an emotional state of the user from the analyzed tone and facial expression.

5. The system according to claim 4, wherein the circuitry is configured to adjust, in real time, the genre and the intensity of the audio content based on the recognized emotional state of the user.

6. The system according to claim 5, wherein the circuitry is configured to regenerate the prompt sentence for the generative AI model when a change in the emotional state or the arousal state exceeds a threshold, and obtain updated audio content from the generative AI model.

7. The system according to claim 1, wherein the circuitry is configured to receive, from the terminal device, biometric sensor data including at least one of eye tracking data, heart rate data, and electroencephalogram data, and use the biometric sensor data as part of the state information for computing the evaluation information.

8. The system according to claim 7, wherein the circuitry is configured to fuse biometric sensor data from a plurality of sensor types, apply a weighting scheme to the fused data, and generate a composite arousal score for determining the genre and the intensity of the audio content.

9. The system according to claim 1, wherein the circuitry is configured to receive feedback from the terminal device indicating whether the transmitted audio data was effective in adjusting the arousal state of the user, and update parameters used in determining the genre and the intensity based on the feedback.

10. The system according to claim 9, wherein the circuitry is configured to maintain a user preference model in a storage device based on accumulated feedback, and use the preference model to personalize the genre and intensity selection for subsequent arousal adjustment sessions.

11. The system according to claim 1, wherein the circuitry is configured to generate the prompt sentence to include at least the determined genre, the determined intensity, a target duration, and a constraint for the generated audio content, and input the prompt sentence to the generative AI model to obtain audio content conforming to the constraints.

12. The system according to claim 11, wherein the circuitry is configured to receive audio content from the generative AI model, apply speech synthesis processing to generate audio data in a playback format, and transmit the audio data to the terminal device for playback via a speaker.

13. The system according to claim 1, wherein the circuitry is configured to monitor changes in the state information received from the terminal device over time, detect transitions in the arousal state, and dynamically adjust the prompt sentence for the generative AI model based on detected transitions.

14. The system according to claim 13, wherein the circuitry is configured to detect a transition from a low arousal state to a moderate arousal state, adjust the genre and intensity of the audio content toward a less stimulating setting, and generate an updated prompt sentence for the generative AI model.

15. The system according to claim 1, wherein the circuitry is configured to receive environmental context data from the terminal device including at least one of ambient noise level, time of day, and location category, and incorporate the environmental context data into the prompt sentence for the generative AI model.

16. The system according to claim 15, wherein the circuitry is configured to adjust the genre and the intensity of the audio content based on the environmental context data in combination with the evaluation information indicating the degree of the arousal state.

17. The system according to claim 1, wherein the circuitry is configured to store a record of state information, evaluation information, generated audio content parameters, and user feedback in a storage device, and use the stored record to improve the mapping from evaluation information to audio genre and intensity over time.

18. A system comprising:
circuitry configured to:
receive, via a communication interface coupled to a packet-switched network, state information from a terminal device, the state information representing an arousal state of a user generated by at least one sensor, and analyze the state information to convert it into an evaluation value indicating a degree of the arousal state;
determine a genre and an intensity of audio content based on the evaluation value, generate a prompt sentence incorporating the determined genre and intensity, and input the prompt sentence to a generative AI model to obtain the audio content;
analyze a tone of voice and a facial expression of the user from data received from the terminal device via the communication interface, recognize an emotional state of the user, and adjust the genre and intensity in real time based on the recognized emotional state; and
transmit audio data generated based on the audio content to the terminal device via the communication interface.

19. The system according to claim 18, wherein the circuitry is configured to receive feedback from the terminal device indicating effectiveness of the transmitted audio data, update a user preference model stored in a storage device based on the feedback, and use the preference model to personalize genre and intensity selection for subsequent sessions.

20. A method comprising:
receiving, via a communication interface coupled to a packet-switched network, state information from a terminal device, the state information being generated by at least one sensor and representing an arousal state of a user, and analyzing the state information to convert it into evaluation information indicating a degree of the arousal state;
determining, based on the evaluation information, a genre and an intensity of audio content, generating a prompt sentence for a generative AI model based on the determined genre and intensity, and inputting the prompt sentence to the generative AI model to instruct generation of the audio content; and
transmitting audio data generated based on the generated audio content to the terminal device via the communication interface.
